(19) United States
(12) Patent Application Publication
(10) Pub. No.: US 2019/0250240 A1
(43) Pub. Date: Aug. 15, 2019

(54) CORRELATION FUNCTION GENERATION DEVICE, CORRELATION FUNCTION GENERATION METHOD, CORRELATION FUNCTION GENERATION PROGRAM, AND WAVE SOURCE DIRECTION ESTIMATION DEVICE

(71) Applicant: NEC CORPORATION, Tokyo (JP)

(72) Inventors: Masanori KATO, Tokyo (JP); Yuzo SENDA, Tokyo (JP)

(73) Assignee: NEC Corporation, Tokyo (JP)

(21) Appl. No.: 16/309,542

(22) PCT Filed: Feb. 3, 2017
(86) PCT No.: PCT/JP2017/004028

§ 371 Date: Dec. 13, 2018

(30) Foreign Application Priority Data
Jun. 29, 2016 (JP) 2016-128486

(51) Int. Cl. G01S 3/808; G10L 25/51; H04R 3/00

(52) U.S. Cl. CPC G01S 3/8083; H04R 3/005; G10L 25/51

(57) ABSTRACT

The present invention generates a correlation function having a clear peak even in an environment with a high ambient noise level. This correlation function generation device is provided with a plurality of input signal acquisition units for acquiring waves generated by a wave source as input signals, a conversion unit for converting the plurality of input signals acquired by the input signal acquisition units into a plurality of frequency-domain signals, a cross-spectrum calculation unit for calculating a cross spectrum on the basis of the frequency domain signals, frequency-specific cross-spectrum calculation units for calculating cross spectrums for each frequency on the basis of the cross spectrum, and an integrated correlation function calculation unit for calculating an integrated correlation function on the basis of the frequency-specific cross spectrums.

### TECHNICAL FIELD

The present invention relates to a correlation function generation device, a correlation function generation method, a correlation function generation program, and a wave source direction estimation device.

### BACKGROUND ART

In the technical field described above, NPT 1 and NPT 2 describe a method of estimating a direction of a sound source (a generation source or a generation place of a sound wave) by using sound receiving signals of two microphones. Specifically, from two sound receiving signals, a cross-correlation function between the sound receiving signals is determined. And, a technique for estimating an incoming direction of a sound wave, by calculating a time difference in which a cross-correlation function indicates a maximum value as an incoming time difference of the sound wave, has been disclosed.

### CITATION LIST

### Non Patent Literature

[NPL 1] C. H. Knapp and G. C. Carter, “The generalized correlation method for estimation of time delay,” IEEE Trans. Acoustics, Speech and Signal Processing, vol. 24, no. 4, pp. 320-327, August 1976
[NPL 2] J. P. Ianniello, “Time delay estimation via cross-correlation in the presence of large estimation errors,” IEEE Trans. Acoustics, Speech and Signal Processing, vol. 30, no. 6, pp. 998-1003, December 1982
[NPL 3] Y. Ephraim and D. Malah, “Speech enhancement using a minimum mean-square error short-time spectral amplitude estimator,” IEEE Trans. Acoust., Speech, Signal Processing, vol. ASSP-32, no. 6, pp. 1109-1121, December 1984
[NPL 4] R. Martin, “Spectral subtraction based on minimum statistics,” Proc. of EUSPICO-94, pp. 1182-1185, September 1994

### SUMMARY OF INVENTION

### Technical Problem

However, in the techniques described in the above-described literatures, when an environment has a high peripheral noise level, it is difficult to generate a correlation function having a clear peak. Further, it is difficult to highly accurately estimate a direction of a wave source.

An object of the present invention is to provide a technique for solving the above-described problems.

### Solution to Problem

In order to achieve the above-described object, a correlation function generation device according to the present invention includes:

a plurality of input signal acquisition means that acquire a wave generated by a wave source as an input signal;

a conversion means that converts a plurality of the input signals acquired by the input signal acquisition means into a plurality of frequency-domain signals;

a cross-spectrum calculation means that calculates a cross-spectrum, based on the frequency-domain signals;

a frequency-specific cross-spectrum calculation means that calculates a frequency-specific cross-spectrum, based on the cross-spectrum; and

an integrated correlation function calculation means that calculates an integrated correlation function, based on the frequency-specific cross-spectrum.

In order to achieve the above-described object, a correlation function generation method according to the present invention includes:

a plurality of input signal acquisition steps of acquiring a wave generated by a wave source as an input signal;

a conversion step of converting a plurality of the input signals acquired in the input signal acquisition steps into a plurality of frequency-domain signals;

a cross-spectrum calculation step of calculating a cross-spectrum, based on the frequency-domain signals;

a frequency-specific cross-spectrum calculation step of calculating a frequency-specific cross-spectrum, based on the cross-spectrum; and

an integrated correlation function calculation step of calculating an integrated correlation function, based on the frequency-specific cross-spectrum.

In order to achieve the above-described object, a correlation function generation program according to the present invention causes a computer to execute:

a plurality of input signal acquisition steps of acquiring a wave generated by a wave source as an input signal;

a conversion step of converting a plurality of the input signals acquired in the input signal acquisition steps into a plurality of frequency-domain signals;

a cross-spectrum calculation step of calculating a cross-spectrum, based on the frequency-domain signals;

a frequency-specific cross-spectrum calculation step of calculating a frequency-specific cross-spectrum, based on the cross-spectrum; and

an integrated correlation function calculation step of calculating an integrated correlation function, based on the frequency-specific cross-spectrum.

In order to achieve the above-described object, a wave source direction estimation device according to the present invention includes:

the above-described correlation function generation device; and

an estimated direction information generation means that generates estimated direction information of a wave source, based on an integrated correlation function.

### Advantageous Effects of Invention

According to the present invention, even when an environment has a high peripheral noise level, a correlation function having a clear peak can be generated. Further, a direction of a wave source can be highly accurately estimated.

### BRIEF DESCRIPTION OF DRAWINGS

FIG. 1 is a block diagram illustrating a configuration of an information processing device according to a first example embodiment of the present invention.

FIG. 2A is a block diagram illustrating a configuration of a wave source direction estimation device according to a second example embodiment of the present invention.

FIG. 2B is a block diagram illustrating a configuration of a frequency-specific cross-spectrum calculation unit included in the wave source direction estimation device according to the second example embodiment of the present invention.

FIG. 2C is a block diagram illustrating a configuration of an integrated correlation function calculation unit included in the wave source direction estimation device according to the second example embodiment of the present invention.

FIG. 3A is diagram illustrating one example of a frequency-specific correlation function acquired by the wave source direction estimation device according to the second example embodiment of the present invention.

FIG. 3B is a diagram illustrating one example of an integrated correlation function in which frequency-specific correlation functions, acquired by the wave source direction estimation device according to the second example embodiment of the present invention, are integrated.

FIG. 4 is diagram illustrating one example of a configuration of an integrated correlation function table included in the wave source direction estimation device according to the second example embodiment of the present invention.

FIG. 5 is a block diagram illustrating a hardware configuration of the wave source direction estimation device according to the second example embodiment of the present invention.

FIG. 6 is a flowchart illustrating a processing procedure of the wave source direction estimation device according to the second example embodiment of the present invention.

FIG. 7 is a block diagram illustrating a configuration of an integrated correlation function generation unit included in a wave source direction estimation device according to a third example embodiment of the present invention.

FIG. 8A is a block diagram illustrating a configuration of a wave source direction estimation device according to a fourth example embodiment of the present invention.

FIG. 8B is a block diagram illustrating a configuration of a frequency-specific cross-spectrum calculation unit included in the wave source direction estimation device according to the fourth example embodiment of the present invention.

FIG. 9 is a diagram illustrating a relation between a frequency-specific cross-spectrum, multiplied by a kernel function spectrum, and a frequency-specific correlation function in the frequency-specific cross-spectrum calculation unit of the wave source direction estimation device according to the fourth example embodiment of the present invention.

FIG. 10 is a diagram illustrating an effect of controlling a height of a frequency-specific correlation function depending on a kernel function in the frequency-specific cross-spectrum calculation unit of the wave source direction estimation device according to the fourth example embodiment of the present invention.

FIG. 11 is a diagram illustrating a relation between a difference of a kernel function spectrum width and an integrated correlation function in the frequency-specific cross-spectrum calculation unit of the wave source direction estimation device according to the fourth example embodiment of the present invention.

FIG. 12 is a diagram illustrating a configuration of a frequency-specific cross-spectrum calculation unit included in a wave source direction estimation device according to a fifth example embodiment of the present invention.

FIG. 13A is a block diagram illustrating a configuration of a wave source direction estimation device according to a sixth example embodiment of the present invention.

FIG. 13B is a block diagram illustrating a configuration of a frequency-specific cross-spectrum included in the wave source direction estimation device according to the sixth example embodiment of the present invention.

FIG. 14 is a diagram illustrating a configuration of a wave source direction estimation system according to a seventh example embodiment of the present invention.

FIG. 15 is a diagram illustrating one example of an image displayed on a display unit of the wave source direction estimation system according to the seventh example embodiment of the present invention.

### EXAMPLE EMBODIMENT

Hereinafter, example embodiments of the present invention are illustratively described in detail with reference to the accompanying drawings. However, a configuration, a numerical value, a flow of processing, and a function element to be described in the following example embodiments are merely one example, are freely varied and modified therefor, and are not intended to limit the technical scope of the present invention to the following description.

Further, an estimation target of a wave source direction estimation device according to the following example embodiments is not limited to a generation source of a sound wave that is a vibration wave of air or water. The estimation target is also applicable to a generation source of a vibration wave in which soil or a solid in an earthquake or landslide is a medium. In this case, as a device that converts a vibration wave into an electric signal, a vibration sensor is used, instead of a microphone. Further, the wave source direction estimation device according to the following example embodiments is also applicable when estimating a direction by using not only a vibration wave of gas, liquid, or solid but also a radio wave. In this case, as a device that converts a radio wave into an electric signal, an antenna is used. In the following example embodiments, assuming that a wave source is a sound source, description is made.

### First Example Embodiment

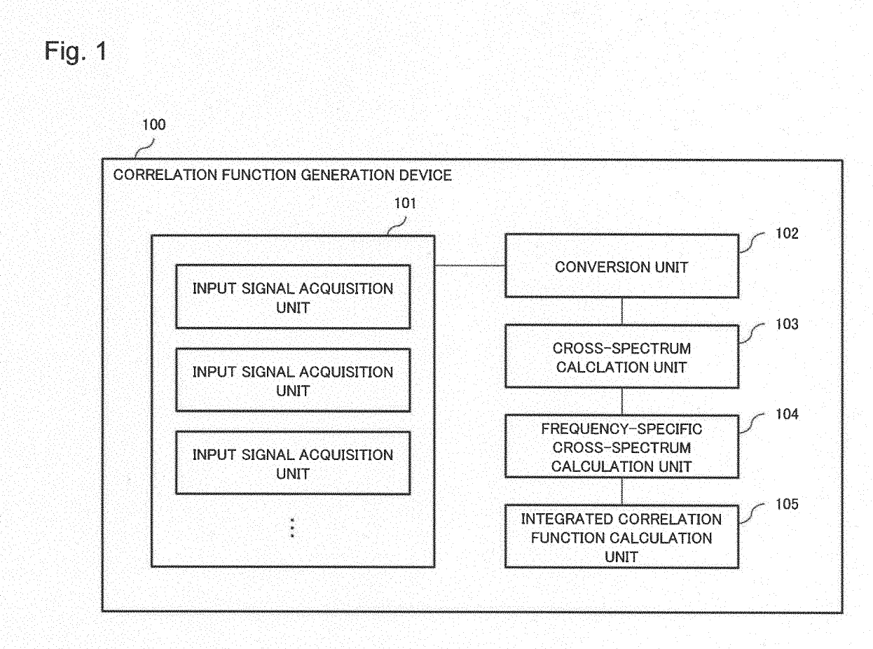

A correlation function generation device 100 as a first example embodiment of the present invention is described by using FIG. 1. The correlation function generation device 100 is a device that generates a correlation function, based on an input signal.

As illustrated in FIG. 1, the correlation function generation device 100 includes an input signal acquisition unit 101, a conversion unit 102, a cross-spectrum calculation unit 103, a frequency-specific cross-spectrum calculation unit 104, and an integrated correlation function calculation unit 105.

A plurality of input signal acquisition units 101 acquire a wave, generated by a wave source, as an input signal. The conversion unit 102 converts a plurality of input signals acquired by the input signal acquisition means into a plurality of frequency-domain signals. The cross-spectrum calculation unit 103 calculates a cross-spectrum, based on the frequency-domain signals. The frequency-specific cross-spectrum calculation unit 104 calculates a frequency-specific cross-spectrum, based on the cross-spectrum. The integrated correlation function calculation unit 105 calculates an integrated correlation function, based on the frequency-specific cross-spectrum.

According to the present example embodiment, even when an environment has a high peripheral noise level, a correlation function having a clear peak can be generated. Further, a direction of a wave source can be highly accurately estimated.

### Second Example Embodiment

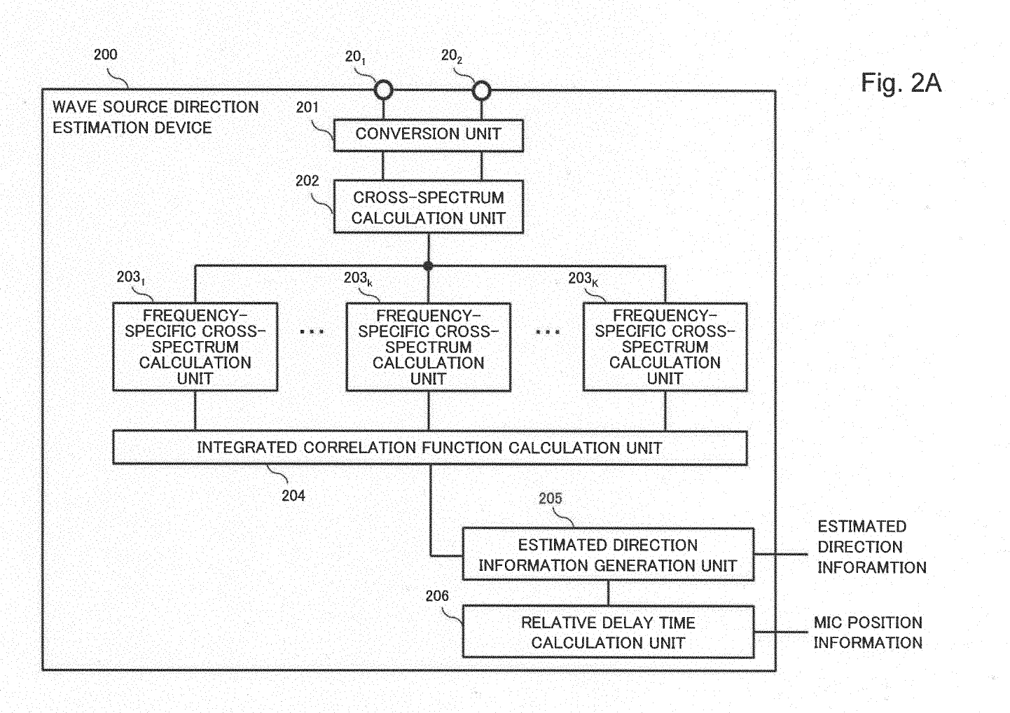

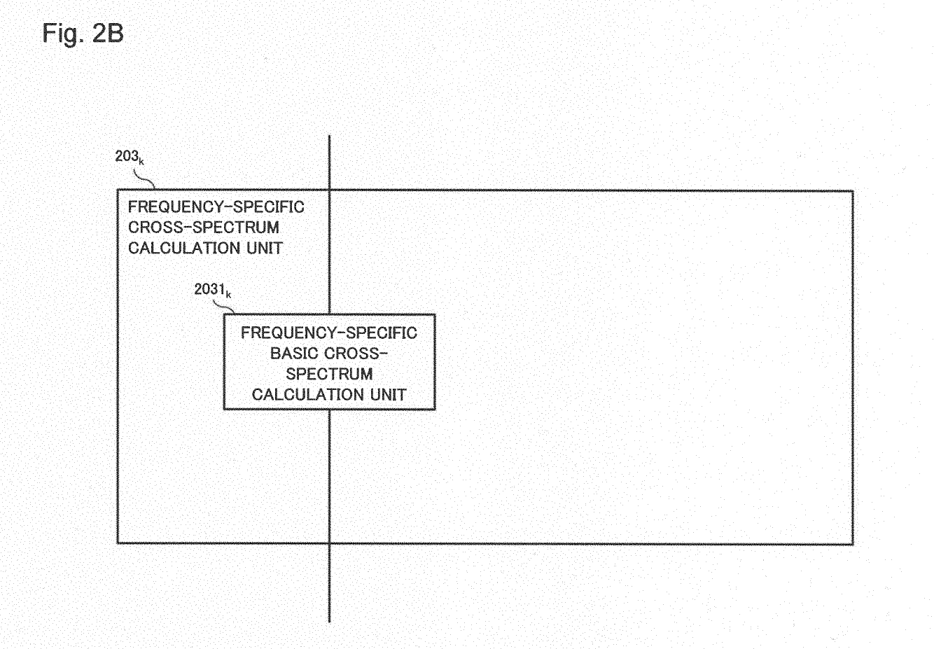

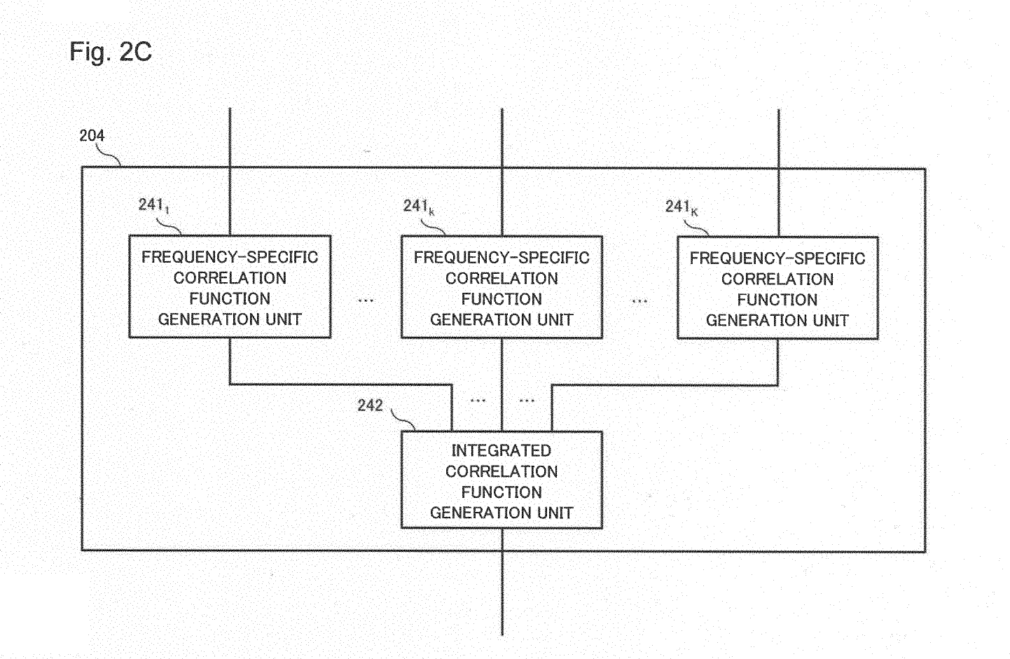

Next, a wave source direction estimation device according to a second example embodiment of the present invention is described by using FIG. 2A to FIG. 6.

### PRIOR ARTS

In the techniques described in NPL 1 and NPL 2 described above, in an environment having a high peripheral noise level such as outdoors and the like, it has been difficult to highly accurately estimate a direction of a sound source existing in the distance. For example, when a sound source of an estimation target (target sound source) exists in a place far away from a microphone, a sound volume of a sound emitted from the target sound source markedly decreases when arriving at the microphone. Therefore, a sound of the target sound source is buried in peripheral environment noise, and therefore it has been difficult to generate a correlation function having a clear peak. Therefore, it has been possible that direction estimation accuracy of a target sound source decreases.

### Technique of the Present Example Embodiment

FIG. 2A is a block diagram illustrating a configuration of the wave source direction estimation device according to the present example embodiment. FIG. 2B is a block diagram illustrating a configuration of an integrated correlation function calculation unit included in the wave source direction estimation device according to the present example embodiment.

A wave source direction estimation device 200 according to the present example embodiment functions as a part of a device such as a digital video camera, a smartphone, a mobile phone, a notebook computer, a passive sonar, and the like. Further, the device is also mounted on an abnormal sound detection device that detects abnormality, based on a voice or sound as in suspiciousness drone detection, scream detection, vehicle accident detection, or the like. However, application examples of the wave source direction estimation device 200 according to the present example embodiment are not limited to these, and the device is applicable to every wave source direction estimation device required to estimate a direction of a target sound source from a receiving sound.

The wave source direction estimation device 200 includes an input terminal 20₁, an input terminal 20₂, a conversion unit 201, a cross-spectrum calculation unit 202, and frequency-specific cross-spectrum calculation units 203₁ to 203ₖ. The wave source direction estimation device 200 further includes an integrated correlation function calculation unit 204, an estimated direction information generation unit 205, and a relative delay time calculation unit 206.

A sound of a target sound source and a sound mixed with various noises generated in a peripheral of a microphone (hereinafter, referred to as a mic), that is a sound collection device, are input to the input terminal 20₁ and the input terminal 20₂ as a digital signal (sample value sequence). A sound signal input to the input terminal 20₁ and an input terminal 20₂ is referred to as an input signal in the present example embodiment. And, an input signal of the input terminal 20₁ and an input signal of the input terminal 20₂ at a time t are represented as x₁(t) and x₂(t), respectively.

A sound input to an input terminal is collected by a mic that is a sound collection device. There are a plurality of input terminals, and therefore when a sound of a target sound source is collected, two mics being the same number as the number of terminals are used at the same time. In the present example embodiment, it is assumed that an input terminal and a mic correspond to each other in a one-to-one basis, and a sound collected by an mth mic is supplied to an mth input terminal. Therefore, an input signal input to the mth input terminal is referred to also as an “mth mic input signal”.

The wave source direction estimation device 200 estimates a direction of a sound source by using a time difference in which a sound of a target sound source arrives at two mics. Therefore, a mic spacing is also important information, and therefore not only an input signal but also mic position information are also supplied to the wave source direction estimation device 200.

The conversion unit 201 converts input signals supplied from the input terminal 20₁ and the input terminal 20₂, and supplies the converted input signals to the cross-spectrum calculation unit 202. The conversion is executed in order to resolve an input signal into a plurality of frequency components. Herein, a case where a representative Fourier transform is used is described.

Two types of input signals xₘ(t) are input to the conversion unit 201. Herein, m is an input terminal number. The conversion unit 201 clips a waveform having an appropriate length from an input signal supplied from an input terminal while being shifted at a fixed cycle. A signal section clipped in such a manner, a length of a clipped waveform, and a cycle for shifting a frame are referred to as a frame, a frame length, and a frame cycle, respectively. And, a signal clipped by using Fourier transform is converted into a frequency-domain signal. When n is designated as a frame number and a clipped input signal is designated as xₘ(t,n) (t=0, 1, . . . , K−1), a Fourier transform Xₘ(k,n) of xₘ(t,n) is calculated as follows.

$$\begin{matrix}[ Math . 1 ] & \\ {X}_{m} ( k , n ) = {\sum }_{t = 0}^{K - 1} {x}_{m} ( t , n ) exp ( - j \frac{2 π tk}{K} ) & ( 1 )\end{matrix}$$

wherein, j represents an imaginary unit (a square root of −1) and exp represents an exponential function. Further, k represents a frequency bin number, and is an integer of equal to or more than 0 and equal to or less than K−1. Hereinafter, for simplification, k is referred to simply as a “frequency” instead of a frequency bin number.

The cross-spectrum calculation unit 202 calculates a cross-spectrum, based on a conversion signal supplied from the conversion unit 201, and transfers the calculated cross-spectrum to frequency-specific cross-spectrum calculation units 203₁, 203₂, . . . , 203_{K}. The cross-spectrum calculation unit 202 calculates a product of a complex conjugate of a conversion signal X₂(k,n) and a conversion signal X₁(k,n). When a cross-spectrum of conversion signals is designated as S₁₂(k,n), a cross-spectrum is calculated as follows.

[Math. 2]

S₁₂(k,n)=X₁(k,n)·conj(X₂(k,n)) (2)

wherein conj(X₂(k,n)) represents a complex conjugate of X₂(k,n).

<Frequency-Domain Cross-Spectrum Calculation Unit>

The frequency-domain cross-spectrum calculation units 203₁, 203₂, . . . , 203_{K} calculate a cross-spectrum corresponding to each frequency k of S₁₂(k,n), by using a cross-spectrum S₁₂(k,n) supplied from the cross-spectrum calculation unit 202, and transfers the calculated cross-spectrum to the integrated correlation function calculation unit 204 as a frequency-specific cross-spectrum. Calculation of a frequency-specific cross-spectrum is executed in order to calculate a correlation function for each frequency component. In other words, in order to determine a correlation function (referred to as a frequency-specific correlation function) corresponding to a certain frequency k in a subsequent stage, a frequency-specific correlation function is calculated.

Next, the frequency-specific cross-spectrum calculation unit 203ₖ that calculates a frequency-specific cross-spectrum of a certain frequency k is described in detail. FIG. 2B is a block diagram of the frequency-specific cross-spectrum calculation unit 203ₖ. The frequency-specific cross-spectrum calculation unit 203ₖ includes a frequency-specific basic cross-spectrum calculation unit 2031ₖ. The frequency-specific cross-spectrum calculation unit 203ₖ calculates a frequency-specific basic cross-spectrum by using a cross-spectrum S₁₂(k,n) supplied from the cross-spectrum calculation unit 202, and transfers the calculated frequency-specific basic cross-spectrum to the integrated correlation function calculation unit 204 as a frequency-specific cross-spectrum. In the frequency-specific basic cross-spectrum calculation unit 2031ₖ, when a frequency-specific basic cross-spectrum is calculated based on a cross-spectrum S₁₂(k,n) of a frequency k, integration is executed after a phase component and an amplitude component are previously determined separately. When a frequency-specific basic cross-spectrum of a frequency k, an amplitude component thereof, and a phase component are respectively designated as Uₖ(w,n), |Uₖ(w,n)|, and arg(Uₖ(w,n)), the following relation is established.

[Math. 3]

Uₖ(w,n)=|Uₖ*(w,n)|exp(j·arg(Uₖ(w,n))) (3)

wherein w represents a frequency, and is an integer equal to or more than 0 and equal to or less than W−1. A method for determining an amplitude component |Uₖ(w,n)| and a phase component arg(Uₖ(w,n)) of a frequency-specific basic cross-spectrum from a cross-spectrum S₁₂(k,n) of a frequency k is described below.

In an amplitude component |Uₖ(w,n)|, as a frequency in which k is subjected to integral multiplication, 1.0 is used. On the other hand, a phase component of a frequency in which a frequency k is subjected to non-constant multiplication is set as 0. When these are expressed as a mathematical equation, an amplitude component |Uₖ(w,n)| is given as follows.

$$\begin{matrix}[ Math . 2 ] & \\ \vert {U}_{k} ( w , n ) \vert = \{ \begin{matrix}1 , & if w = p \cdot k \\ 0 , & if w \neq p \cdot k\end{matrix} & ( 2 )\end{matrix}$$

wherein p is an integer equal to or more than 1 and equal to or less than P. Information, that is important when wave source direction estimation is executed, is a phase component, and therefore as an amplitude component, an appropriate constant is used in this manner. Other than this, instead of 1.0, |S₁₂(k,n)| is usable. In other words, an amplitude component |Uₖ(w,n)| may be determined as in the following equation.

$$\begin{matrix}[ Math . 5 ] & \\ \vert {U}_{k} ( w , n ) \vert = \{ \begin{matrix}\vert {S}_{12} ( k , n ) \vert , & if w = p \cdot k \\ 0 , & if w \neq p \cdot k\end{matrix} & ( 5 )\end{matrix}$$

In a phase component arg(Uₖ(w,n)), as a frequency in which k is subjected to integral multiplication, a component in which a cross-spectrum S₁₂(k,n) of a frequency k is subjected to constant multiplication is used. For example, as phase components of frequencies k, 2 k, 3 k, and 4 k, components in which a phase component arg(S₁₂(k,n)) of a frequency k is subjected to integral multiplication at the same amplification for each, i.e. arg(S₁₂(k,n)), 2arg(S₁₂(k,n)), 3arg(S₁₂(k,n)), and 4arg(S₁₂(k,n)), are used. On the other hand, a phase component of a frequency in which a frequency k is subjected to non-constant multiplication is set as 0. Therefore, a phase component arg(Uₖ(w,n)) of a frequency-specific basic cross-spectrum corresponding to a frequency k is calculated as follows.

$$\begin{matrix}[ Math . 6 ] & \\ arg ( {U}_{k} ( w , n ) ) = \{ \begin{matrix}p \cdot arg ( {S}_{12} ( k , n ) ) , & if w = p \cdot k \\ 0 , & if w \neq p \cdot k\end{matrix} & ( 6 )\end{matrix}$$

wherein p is an integer equal to or more than 1 and equal to or less than P. Further, P is an integer more than 1.

An amplitude component and a phase component determined by the above-described method are integrated by using equation (3) described above, and a frequency-specific basic cross-spectrum Uₖ(w,n) of a frequency k is acquired.

In the method described so far, a frequency-specific spectrum was acquired by separately determining an amplitude component and a phase component. However, when a power of a cross-spectrum is used as represented in a mathematical equation described below, a frequency-specific spectrum Uₖ(w,n) can be determined without determining an amplitude component and a phase component.

$$\begin{matrix}[ Math . 7 ] & \\ {U}_{k} ( w , n ) = \{ \begin{matrix}{( \frac{{S}_{12} ( k , n )}{\vert {S}_{12} ( k , n ) \vert} )}^{p} , & if w = p \cdot k \\ 0 , & if w \neq p \cdot k\end{matrix} & ( 7 )\end{matrix}$$

The integrated correlation function calculation unit 204 calculates an integrated correlation function, based on frequency-specific cross-spectra supplied from the frequency-specific cross-spectrum calculation units 203₁, 203₂, . . . , 203_{K}, and transfers the calculated integrated correlation function to the estimated direction information generation unit 205.

<Integrated Correlation Function Calculation Unit>

FIG. 2C is a block diagram illustrating a configuration of the integrated correlation function calculation 204 unit included in the wave source direction estimation device 200 according to the present example embodiment. The integrated correlation function calculation unit 204 includes frequency-specific correlation function generation units 241₁, 241₂, . . . , 241_{K} and an integration unit 242.

The frequency-specific correlation function generation units 241₁, 241₂, . . . , 241_{K} inversely convert frequency-specific cross-spectra supplied from the frequency-specific cross-spectrum calculation units 203₁, 203₂, . . . , 203_{K}, and transfer the inversely-converted frequency-specific cross-spectra to the integration unit 242 as frequency-specific correlation functions, respectively. In the present example embodiment, in the conversion unit 201, Fourier transform was used, and therefore with regard to inverse conversion, a method using inverse Fourier transform is described. When a frequency-specific cross-spectrum supplied from the frequency-specific cross-spectrum calculation unit 203ₖ is designated as Uₖ(w,n), a frequency-specific correlation function uₖ(τ,n) acquired by inversely converting Uₖ(w,n) is calculated as follows.

$$\begin{matrix}[ Math . 8 ] & \\ {u}_{k} ( τ , n ) = {\sum }_{w = 0}^{W - 1} {U}_{k} ( w , n ) exp ( j \frac{2 πτ w}{W} ) & ( 8 )\end{matrix}$$

The integration unit 242 integrates frequency-specific correlation functions supplied from the frequency-specific correlation function generation units 241₁, 241₂, . . . , 241_{K}, and transfers to the estimated direction information generation unit 205 as an integrated correlation function. A plurality of frequency-specific correlation functions individually determined are mixed or overlapped, and thereby one correlation function is determined. When a simple sum is used for an integration method, the integration unit 242 calculates a total sum of frequency-specific correlation functions. When an integrated correlation function is designated as u(τ,n), u(τ,n) is calculated as follows.

$$\begin{matrix}[ Math . 9 ] & \\ \begin{matrix}u ( τ , n ) = {u}_{0} ( τ , n ) + {u}_{1} ( τ , n ) + ⋯ + {u}_{K - 1} ( τ , n ) \\ = {\sum }_{k = 0}^{K - 1} {u}_{k} ( τ , n )\end{matrix} & ( 9 )\end{matrix}$$

Further, a total product is usable, instead of a total sum. In this case, u(τ,n) is calculated as follows.

$$\begin{matrix}[ Math . 10 ] & \\ \begin{matrix}u ( τ , n ) = {u}_{0} ( τ , n ) + {u}_{1} ( τ , n ) ⋯ {u}_{K - 1} ( τ , n ) \\ = {\sum }_{k = 0}^{K - 1} {u}_{k} ( τ , n )\end{matrix} & ( 10 )\end{matrix}$$

When a frequency in which a target sound exists or a frequency in which a power of a target sound is large is previously known, an integrated correlation function may be determined by using only a frequency-specific correlation function corresponding to the frequency. Further, an influence degree of a frequency-specific correlation function in integration may be controlled via weighting. When, for example, a set of frequencies in which a target sound exists is designated as Ω, upon determining u(τ,n) by selecting a frequency, calculation is executed as follows.

$$\begin{matrix}[ Math . 11 ] & \\ u ( τ , n ) = {\sum }_{k ∈ Ω} {u}_{k} ( τ , n ) & ( 11 )\end{matrix}$$

Further, when weighting is used, u(τ,n) is calculated as follows.

$$\begin{matrix}[ Math . 12 ] & \\ {u}_{k} ( τ , n ) = {\sum }_{w = 0}^{W - 1} {U}_{k} ( w , n ) exp ( j \frac{2 πτ w}{W} ) & ( 12 )\end{matrix}$$

wherein a and b each are a real number and satisfy a>b>0. In this manner, when a frequency-specific correlation function of a frequency in which a target sound exists is mainly used and integration is executed, a correlation function in which an influence of a non-target sound such as noise is small can be generated, and therefore direction estimation accuracy is improved.

The relative delay time calculation unit 206 determines a relative delay time between paired mics from input mic position information and a sound source search target direction, and transfers the determined relative delay time to the estimated direction information generation unit 205, as a set with the sound source search target direction. A relative delay time refers to an arrival time difference of a sound wave, which is uniquely determined based on a mic spacing and a sound source direction. Assuming that a sound speed is c, when a spacing of two mics is designated as d and a sound source direction, i.e. an incoming direction of a sound is designated as θ, a relative delay time τ(θ) with respect to the sound source direction θ is calculated as follows.

$$\begin{matrix}[ Math . 13 ] & \\ τ ( θ ) = \frac{d cos θ}{c} & ( 13 )\end{matrix}$$

A relative delay time is calculated for all sound source search target directions. When, for example, a direction search range is 0 degrees to 90 degrees at a 10-degree step, i.e. 0 degrees, 10 degrees, 20 degrees, . . . , 90 degrees, 10 types of relative delay limes are calculated. And, a pair of a direction of a search target and a relative delay time is supplied to the estimated direction information generation unit 205.

The estimated direction information generation unit 205 outputs a correspondence relation between a direction and a correlation value, as estimated direction information, based on an integrated correlation function supplied from the integrated correlation function calculation unit 204 and a relative delay time supplied from the relative delay time calculation unit 206. When a correlation function is designated as u(τ,n) and a relative delay time is designated as τ(θ), estimated direction information H(θ,n) is given as the following equation.

[Math. 14]

H(θ,n)γu(τ(θ),n) (14)

A correlation value is determined for each direction, and therefore when a correlation value is basically high, it can be determined that it is highly possible for a sound source to exist in the direction.

Such estimated direction information is used in various forms. When, for example, a function has a plurality of peaks, it is conceivable that a plurality of sound sources in which each peak corresponds to an incoming direction exist. Therefore, direction of each sound source can be estimated at the same time, and it is also possible to be used for estimating the number of sound sources.

Further, an existence possibility of a sound source can be also determined based on a difference between a peak and a non-peak of a correlation function. When a difference between a peak and a non-peak is large, it can be determined that an existence possibility of a sound source is high. At the same time, it can be also determined that reliability of an estimated direction is high. When it can be previously assumed that the number of sound sources is one, a direction in which a correlation value is maximum may be output as estimated direction information. In this case, the estimated direction information is not a correspondence relation between a direction and a correlation value, but a direction itself.

<Description of Frequency-Specific Cross-Spectrum>

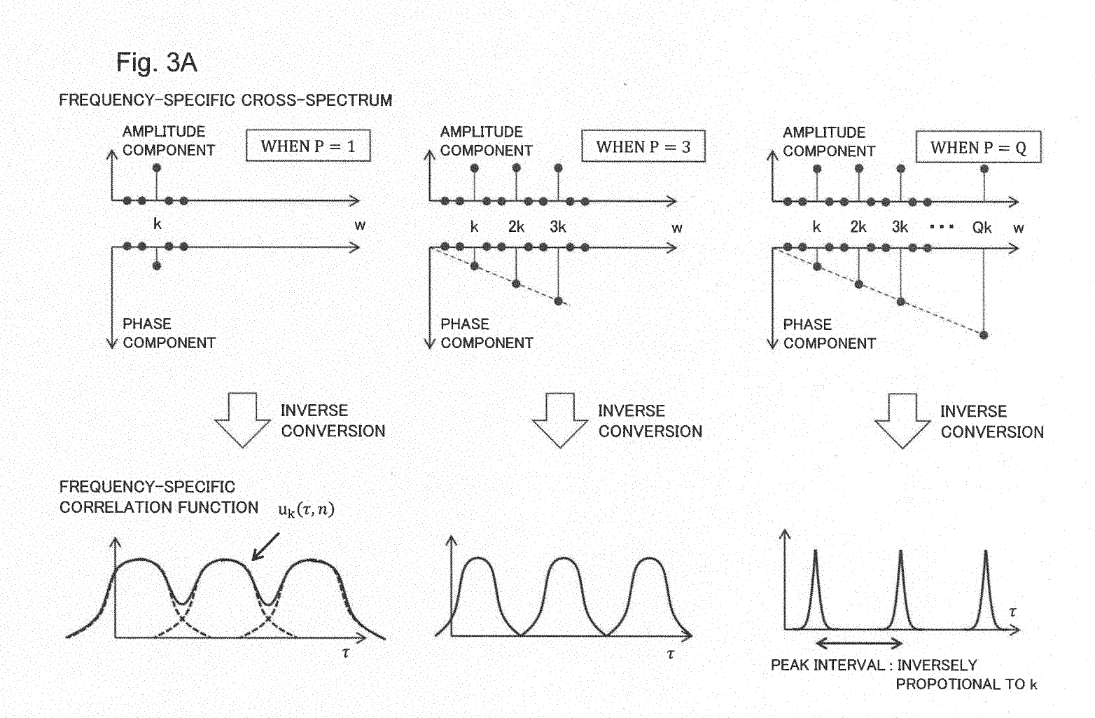

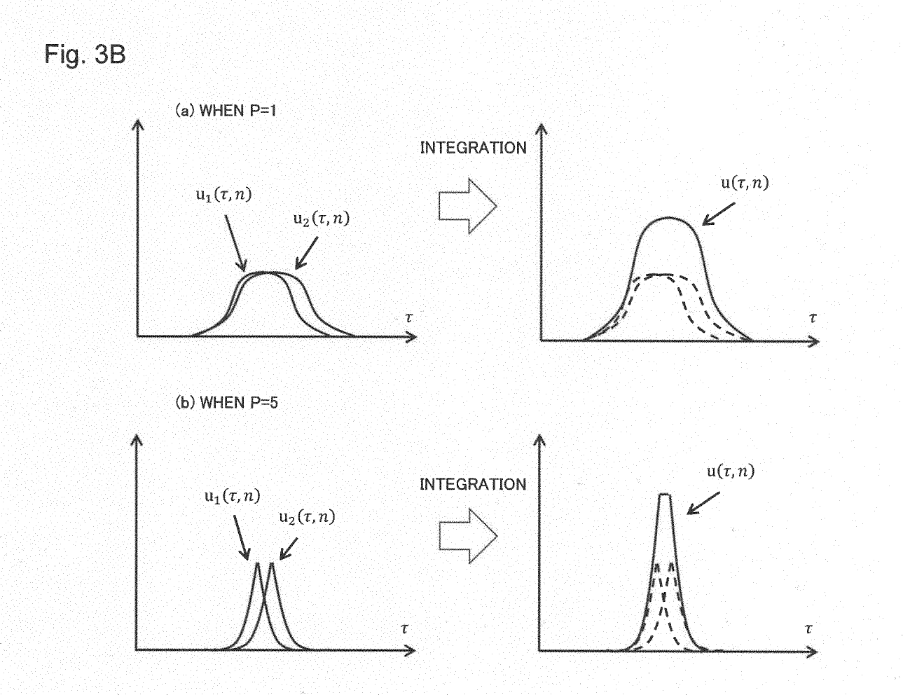

When a frequency-specific cross-spectrum is calculated by the above-described method, a peak of a frequency-specific correlation function acquired by inversely converting a frequency-specific cross-spectrum becomes sharp, and a peak position of a correlation function becomes clear. In the present example embodiment in which wave source direction estimation is executed based on a peak position of a correlation function, when a peak becomes sharp, accuracy in sound source direction estimation is improved. Further, as a value of P is larger, i.e. a component of a frequency in which k is subjected to integral multiplication increases, a peak of a correlation function becomes sharper. FIG. 3A illustrates this situation. Herein, Q in the figure is an integer more than 3. When P=1, i.e. there is only one phase component, a correlation function acquired by inverse conversion thereof is a correlation function in which a peak position is unclear in this manner. When P becomes large, a peak of a correlation function becomes sharp, as illustrated in FIG. 3A.

Therefore, in the present invention, a frequency-specific cross-spectrum is defined as “a spectrum in which a phase component of a frequency pk where a certain frequency k is subjected to integral multiplication is allocated with a value in which a phase component arg(S₁₂(k,n)) of the frequency k is multiplied by p”, based on a cross-spectrum of the frequency k. Herein, p is an integer equal to or more than 1. In other words, a frequency-specific cross-spectrum is defined as a spectrum in which a phase component arg(Uₖ(w,n)) thereof satisfies at least the following equation.

[Math. 15]

arg(Uₖ(w,n))=p·arg(S₁₂(k,n)), if w=p·k (15)

In addition, p is limited to a number equal to or more than 2 such as p=1 and 2, p=1 and 3, p=2 and 3. When p is only 1, a frequency-specific cross-spectrum is generated by extracting only a component of a frequency k, and therefore direction estimation accuracy is equivalent to a conventional technique, and it is difficult to achieve high accuracy in direction estimation. Note that as illustrated in FIG. 3A, when the number of p increases as in p=1, 2, 3, 4 . . . , i.e. an allocation to a phase component of a frequency pk increases, a peak of a frequency-specific correlation function becomes sharper, and therefore accuracy in direction estimation is improved.

An effect of increasing P upon calculating a frequency-specific spectrum is described by suing FIG. 3B. FIG. 3B is a diagram illustrating one example of two frequency-specific correlation functions and an integrated correlation function in which these are integrated, for the case of different P=1 and P=5. As illustrated in the lower side of FIG. 3B, a peak of a frequency-specific correlation function periodically appears, and a peak interval thereof is inversely proportional to a frequency k. When a frequency k becomes high, peaks of two adjacent frequency-specific correlation functions are close to each other, and the peaks are not distinguished due to overlapping of the correlation functions. When P=1, a peak of a frequency-specific correlation function is not sharp, and therefore a peak of an integrated function acquired by integration is also smooth. Therefore, an estimated direction is unclear. On the other hand, when P=5, frequency-specific correlation functions and a peak of an integrated correlation function thereof is sharp. Therefore, an estimated direction is clear, leading to improvement of estimation accuracy.

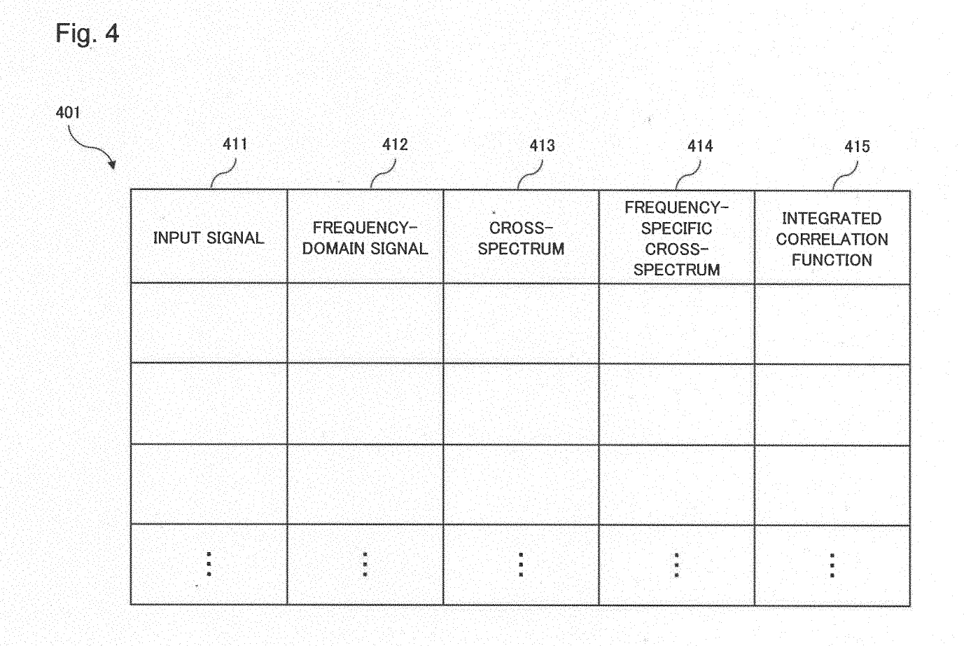

FIG. 4 is diagram illustrating one example of a configuration of an integrated correlation function table 401 included in the wave source direction estimation device 200 according to the present example embodiment. The integrated correlation function table 401 stores a frequency-domain signal 412, a cross-spectrum 413, a frequency-specific cross-spectrum 414, and an integrated correlation function 415 in association with an input signal 411. The wave source direction estimation device 200 may calculate an integrated correlation function every time an input signal is acquired, or may calculate an integrated correlation function by referring to the integrated correlation function table 401 after previously determining an integrated correlation function corresponding to an input signal.

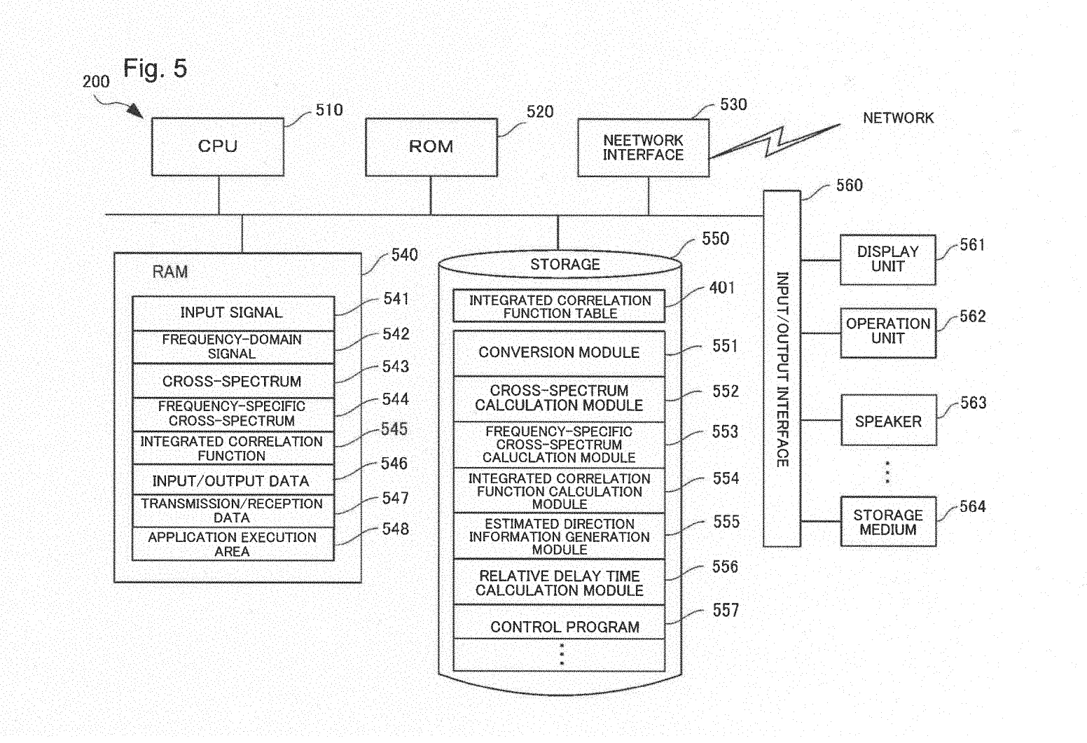

FIG. 5 is a block diagram illustrating a hardware configuration of the wave source direction estimation device 200 according to the present example embodiment.

A central processing unit (CPU) 510 is a processor for arithmetic control, and achieves a function configuring unit of the wave source direction estimation device 200 of FIG. 2A by executing a program. A read only memory (ROM) 520 stores fixed data such as initial data and a program, and a program. Further, the communication control unit 530 communicates with other devices and the like via a network. Note that the CPU 510 is not limited to one unit, and may include a plurality of CPUs or a graphics processing unit (GPU) for image processing. Further, the communication control unit 530 preferably includes a CPU independent of the CPU 510, and writes or reads transmission and reception data onto or from an area of a random access memory (RAM) 540. Furthermore, a direct memory access controller (DMAC) that transfers data between the RAM 540 and a storage 550 is preferably provided (not illustrated). Moreover, an input/output interface 560 preferably includes a CPU independent of the CPU 510, and writes or reads input/output data onto or from an area of the RAM 540. Therefore, the CPU 510 recognizes that data have been received by or transferred to the RAM 540, and processes the data. Further, the CPU 510 prepares a processing result in the RAM 540, and entrusts subsequent transmission or transfer to the communication control unit 530, the DMAC, or the input/output interface 560.

The RAM 540 is a random access memory used as a temporary storage work area by the CPU 510. In the RAM 540, an area for storing data necessary for achieving the present example embodiment is provided. The input signal 541 is sound signal data collected by a sound collection device such as a mic, or signal data input to an input signal acquisition device or the like and acquired thereby.

A frequency-domain signal 542 is a signal acquired by converting the input signal 541 by the conversion unit 201. A cross-spectrum 543 is a spectrum calculated by the cross-spectrum calculation unit 202. A frequency-specific cross-spectrum 544 is a spectrum calculated by the frequency-specific cross-spectrum calculation unit 203ₖ. An integrated correlation function 545 is a function calculated by the integrated correlation function calculation unit 204.

Input/output data 546 are data input/output via the input/output interface 560. Transmission/reception data 547 are data transmitted/received via the network interface 530. Further, the RAM 540 includes an application execution area 548 for executing various types of application modules.

The storage 550 stores a database and various types of parameters, or the following data or program necessary for achieving the present example embodiment. The storage 550 stores the integrated correlation function table 401. The integrated correlation function table 401 is a table that manages a relation between an input signal and an integrated correlation function illustrated in FIG. 4.

The storage 550 further stores a conversion module 551, a cross-spectrum calculation module 552, a frequency-specific cross-spectrum calculation module 553, and an integrated correlation function calculation module 554. Further, the storage 550 stores an estimated direction information generation module 555 and a relative delay time calculation module 556.

The conversion module 551 is a module that converts an input signal into a frequency-domain signal. The cross-spectrum calculation module 552 is a module that calculates a cross-spectrum, based on a frequency-domain signal. The frequency-specific cross-spectrum calculation module 553 is a module that calculates a frequency-specific cross-spectrum by using a cross-spectrum. The integrated correlation function calculation module 554 is a module that calculates an integrated correlation function, based on frequency-specific cross-spectra.

The estimated direction information generation module 555 is a module that generates estimated direction information of a wave source, based on an integrated envelope function. The relative delay time calculation module 556 is a module that calculates a relative delay time. These modules 551 to 556 are loaded into the application execution area 548 of the RAM 540 by the CPU 510 and then executed. A control program 557 is a program for controlling the entire wave source direction estimation device 200.

The input/output interface 560 interfaces input/output data to an input/output device. The input/output interface 560 is connected with a display unit 561 and an operation unit 562. Further, the input/output interface 560 may be further connected with a storage medium 564.

Furthermore, a speaker 563 that is a sound output unit, a mic that is a sound input unit, or a GPS position determination unit may be connected. Note that for the RAM 540 and the storage 550 illustrated in FIG. 5, programs and data related to general-purpose functions and other achievable functions are not illustrated.

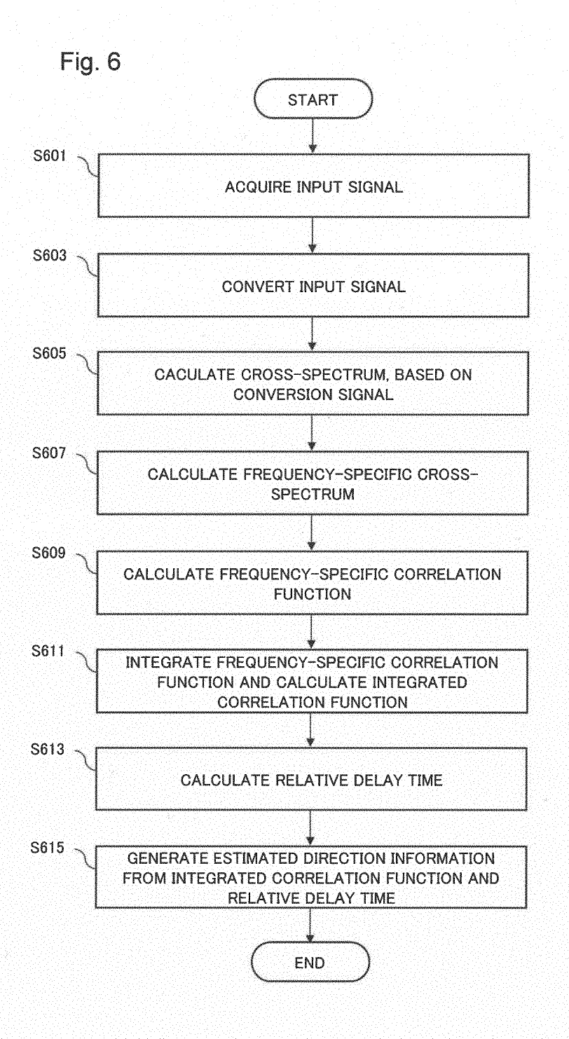

FIG. 6 is a flowchart illustrating a processing procedure of the wave source direction estimation device 200 according to the present example embodiment. The flowchart is executed by the CPU 510 of FIG. 5 with using the RAM 540, and achieves a function configuring unit of the wave source direction estimation device 200 of FIG. 2.

In step S601, the wave source direction estimation device 200 acquires an input signal. In step S603, the conversion unit 201 of the wave source direction estimation device 200 converts input signals supplied from the input terminal 20₁ and the input terminal 20₂. The conversion unit 201 supplies frequency-domain signals acquired by the conversion to the cross-spectrum calculation unit 202. In step S604, the cross-spectrum calculation unit 202 calculates a cross-spectrum, based on the supplied conversion signals. The cross-spectrum calculation unit 202 transfers the calculated cross-spectrum to the frequency-specific cross-spectrum calculation units 203₁, 203ₖ, . . . , 203_{K}.

In step S607, the frequency-specific cross-spectrum calculation units 203₁, 203ₖ, . . . , 203_{K} calculate a cross-spectrum corresponding to each frequency k of the cross-spectrum. In other words, the frequency-specific cross-spectrum calculation units 203₁, 203ₖ, . . . , 203_{K} calculate frequency-specific cross-spectra. And, the frequency-specific cross-spectrum calculation units 203₁, 203ₖ, . . . , 203_{K} transfer the frequency-specific cross-spectra to the integrated correlation function calculation unit 204.

In step S609, the frequency-specific correlation function generation units 241₁, 241₂, . . . , 241_{K} inversely convert the frequency-specific cross-spectra, and calculates frequency-specific correlation functions. In step S611, the integration unit 242 integrates the frequency-specific correlation functions, and calculates an integrated correlation function.

In step S613, the relative delay time calculation unit 206 calculates a relative delay time between paired mics from mic position information and a sound source search target direction. In step S615, the estimated direction information generation unit 205 generates estimated direction information from the integrated correlation function and the relative delay time.

According to the present example embodiment, an incoming direction of a target sound included in an input signal, i.e. a direction where a target object exists, is estimated. An effect is produced when, in an environment having a high environment noise level, a direction where a target object exists is estimated by using a sound emitted by the target object as a clue. As examples of the environment noise, a bustling area, a street, a street alongside, and a place where a large number of people and automobiles gather together are cited. Further, as examples of the target object, a human being, an animal, an automobile, an aircraft, a ship, a personal watercraft, and a drone (small unmanned aircraft) are cited.

For example, a suspicious automobile, ship, drone, or the like being approaching an outdoor theme park, exhibition site, and the like is detected, and a direction thereof is estimated, and thereby a suspicious person or a suspicious object can be efficiently regulated. Further, when sound source direction estimation is executed in a plurality of points, a position of a target sound source can be identified. Thereby, even in an environment having a high environment noise level, an occurrence point of a scream, a gunshot sound, and a collision sound of an automobile can be accurately identified.

### Third Example Embodiment

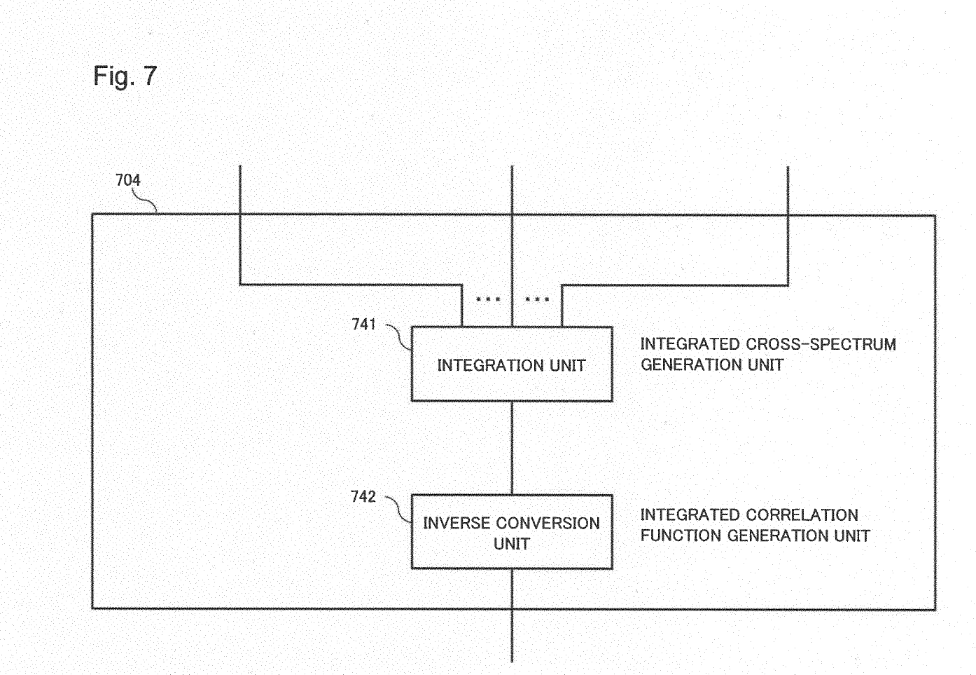

Next, a wave source direction estimation device according to a third example embodiment of the present invention is described by using FIG. 7. FIG. 7 is a block diagram illustrating a configuration of an integrated correlation function generation unit 704 included in the wave source direction estimation device according to the present example embodiment. The integrated correlation function generation unit 704 included in the wave source direction estimation device according to the present example embodiment is different from the integrated correlation function generation unit 204 of the second example embodiment in a point that instead of the frequency-specific correlation function generation units 241₁, 241₂, . . . , 241_{K} and the integration unit 242, an integration unit 741 and an integrated correlation function generation unit 742 are included. Other components and operations are similar to the second example embodiment, and therefore the same component and operation are assigned with the same reference signs and detailed description thereof is omitted.

The integration unit 741 integrates frequency-specific cross-spectra supplied from frequency-specific cross-spectrum calculation units 203₁, 203₂, . . . , 203_{K}, and transfers to the integrated correlation function generation unit 742 as an integrated cross-spectrum. A plurality of frequency-specific cross-spectra individually determined are mixed or overlapped, and thereby one integrated cross-spectrum is determined. In the integration, a total sum or a total product is used, similarly to the integration unit 242 of the second example embodiment. When a total sum is used for integration, an integrated cross-spectrum U(k,n) is calculated as follows.

$$\begin{matrix} [ Math . 16 ] & \\ U ( k , n ) = {U}_{k} ( 0 , n ) + {U}_{k} ( 1 , n ) + … + {U}_{k} ( w - 1 , n ) = {\sum }_{w = 0}^{W - 1} {U}_{k} ( w , n ) & ( 16 )\end{matrix}$$

Further, when a total product is used, an integrated cross-spectrum U(k,n) is calculated as follows.

$$\begin{matrix}[ Math . 17 ] & \\ U ( k , n ) = {U}_{k} ( 0 , n ) \cdot {U}_{k} ( 1 , n ) \cdot … \cdot {U}_{k} ( w - 1 , n ) = {\sum }_{w = 0}^{W - 1} {U}_{k} ( w , n ) & ( 17 )\end{matrix}$$

Similarly to the integration unit 242 of the second example embodiment, when a frequency in which a target sound source exists or a frequency in which a power of a target sound source is large is previously known, correction may be made when an integrated cross-spectrum U(k,n) is generated. Similarly to the second example embodiment, an influence degree is controlled via selection of a frequency or weighting. When, for example, a set of frequencies in which a target sound exists is designated as Ω, upon determining an integrated cross-spectrum U(k,n) by selecting a band, calculation is executed as follows.

$$\begin{matrix}[ Math . 18 ] & \\ U ( k , n ) = \{ \begin{matrix}{\sum }_{w = 0}^{W - 1} {U}_{k} ( w , n ) & k ∈ Ω \\ 0 & k ∉ Ω\end{matrix} & ( 18 )\end{matrix}$$

Further, when weighting is used, U(k,n) is calculated as follows.

$$\begin{matrix}[ Math . 19 ] & \\ U ( k , n ) = \{ \begin{matrix}a \cdot {\sum }_{w = 0}^{W - 1} {U}_{k} ( w , n ) & k ∈ Ω \\ b \cdot {\sum }_{w = 0}^{W - 1} {U}_{k} ( w , n ) & k ∉ Ω\end{matrix} & ( 19 )\end{matrix}$$

wherein a and b each are a real number and satisfy a>b>0. In this manner, when a frequency-specific correlation function of a frequency in which a target sound exists is mainly used and integration is executed, a correlation function in which an influence of a non-target sound such as noise is small can be generated, and therefore direction estimation accuracy is improved.

The integrated correlation function generation unit 742 inversely converts an integrated cross-spectrum supplied from the integration unit 741, and transfers to an estimated direction information generation unit 205 as an integrated correlation function. Also, in the present example embodiment, a method using inverse Fourier transform for inverse conversion is described. When an integrated cross-spectrum supplied from the integration unit 741 is designated as U(k,n), an integrated correlation function u(τ,n) acquired by inversely converting U(k,n) is calculated as follows.

$$\begin{matrix}[ Math . 20 ] & \\ u ( τ , n ) = {\sum }_{k = 0}^{K - 1} U ( k , n ) exp ( j \frac{2 π τ k}{K} ) & ( 20 )\end{matrix}$$

According to the present example embodiment, frequency-specific cross-spectra are integrated and inverse conversion is executed, and thereby an integrated correlation function is acquired. Therefore, compared with the second example embodiment in which inverse conversion is executed for each frequency-specific cross-spectrum, the number of times of inverse conversion decreases. Therefore, an integrated correlation function can be determined by using a calculation amount less than in the second example embodiment.

### Fourth Example Embodiment

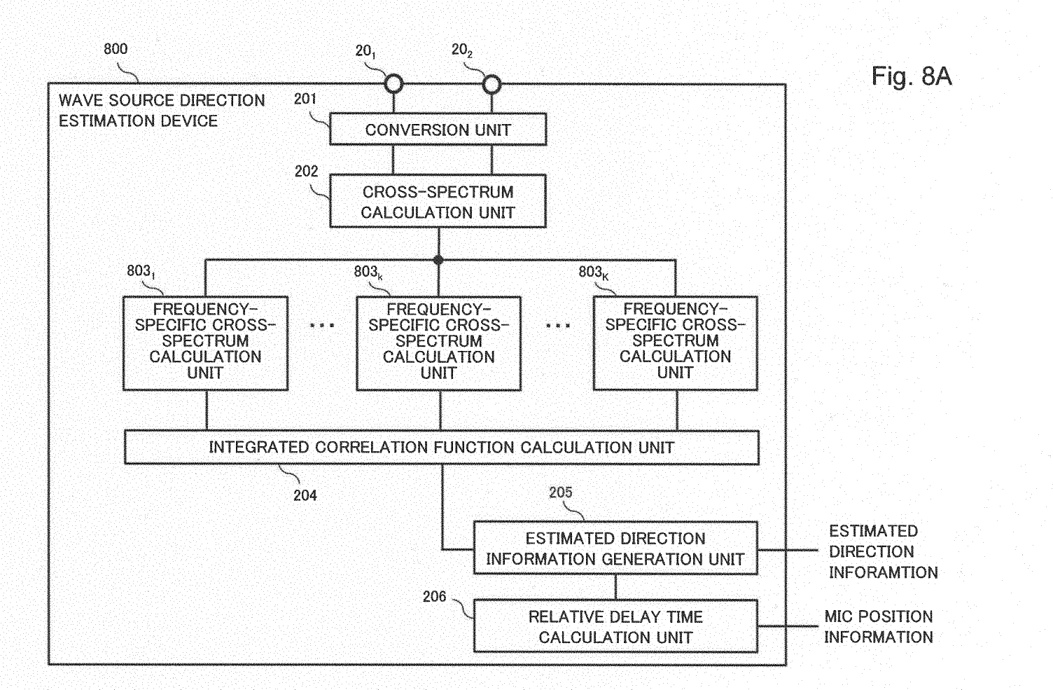

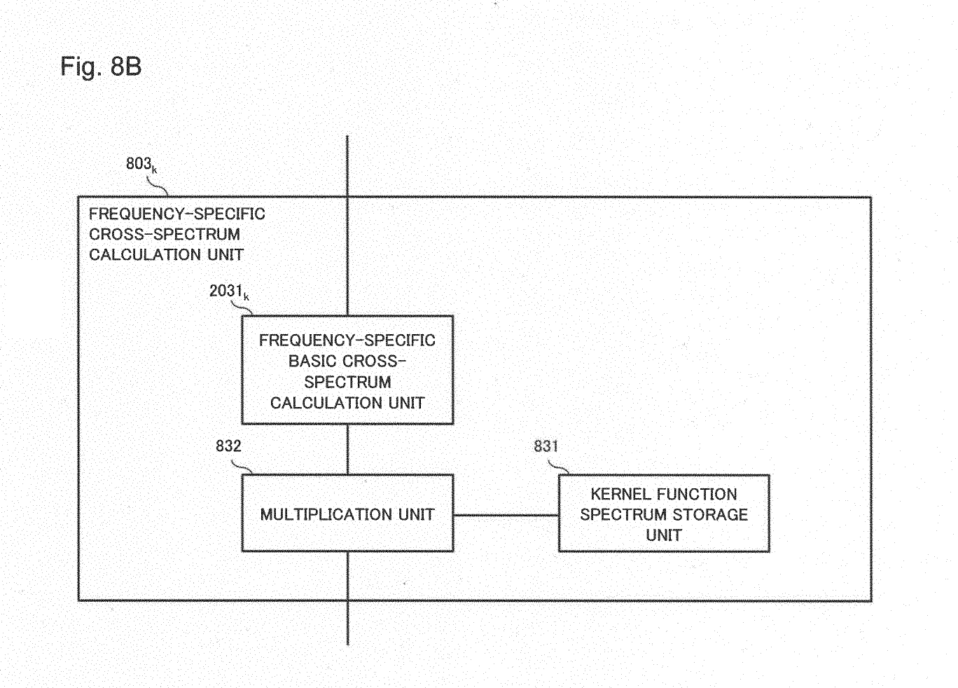

Next, a wave source direction estimation device according to a fourth example embodiment of the present invention is described by using FIG. 8A to FIG. 11. FIG. 8A is a block diagram illustrating a configuration of a wave source direction estimation device 800 according to the present example embodiment. The wave source direction estimation device 800 according to the present example embodiment is different from the second example embodiment in a point that instead of the frequency-specific cross-spectrum calculation units 203₁, 203₂, . . . , 203_{K}, frequency-specific cross-spectrum calculation units 803₁, 803₂, . . . , 803_{K} are included. Other components and operations are similar to the first example embodiment, and therefore the same component and operation are assigned with the same reference signs and detailed description thereof is omitted.

FIG. 8B is a block diagram of the frequency-specific cross-spectrum calculation unit 803ₖ. The frequency-specific cross-spectrum calculation unit 803ₖ includes a frequency-specific basic cross-spectrum calculation unit 2031ₖ, a kernel function spectrum storage unit 831, and a multiplication unit 832. The frequency-specific basic cross-spectrum calculation unit 2031ₖ calculates, by using a cross-spectrum S₁₂(k,n) supplied from a cross-spectrum calculation unit 202, a cross-spectrum corresponding to a frequency k of S₁₂(k,n), and transfers to the multiplication unit 832 as a frequency-specific basic cross-spectrum. An operation of the frequency-specific basic cross-spectrum calculation unit 2031ₖ is similar, except for the output destination, to the frequency-specific basic cross-spectrum calculation unit 2031ₖ of the second example embodiment, and therefore detailed description is omitted.

The kernel function spectrum storage unit 831 stores a kernel function spectrum, and output a kernel function spectrum to the multiplication unit 832. The kernel function spectrum refers to a spectrum in which a kernel function is subjected to Fourier transform and an absolute value thereof is taken. Instead of taking an absolute value, squaring may be executed. As a kernel function, a Gaussian function is used. The Gaussian function is given by a mathematical equation as follows, by using three previously-given real numbers g₁, g₂, and g₃.

$$\begin{matrix}[ Math . 21 ] & \\ g ( τ ) = {g}_{1} exp ( - \frac{{( τ - {g}_{2} )}^{2}}{2 {g}_{3}^{2}} ) & ( 21 )\end{matrix}$$

wherein g₁ controls a height of a Gaussian function, g₂ controls a position of a peak of the Gaussian function, and g₃ controls width of the Gaussian function. In particular, g₃ that adjusts width of a Gaussian function is important, since largely affecting sharpness of a peak of a frequency-specific correlation function. As can be seen from equation (21), when g₃ is large, width of a Gaussian function increases.

Other than this, a logistic function described below is usable.

$$\begin{matrix}[ Math . 22 ] & \\ g ( τ ) = \frac{exp ( - \frac{τ - {g}_{4}}{{g}_{5}} )}{{{g}_{5} ( 1 + exp ( - \frac{τ - {g}_{4}}{{g}_{5}} ) )}^{2}} & ( 22 )\end{matrix}$$

wherein g₁ and g₂ each are a real number. A logistic function has a shape similar to a Gaussian function, but has a nature in which a tail is longer than a tail of a Gaussian function. In particular, g₅ that adjusts width of a logistic function is an important parameter that largely affects sharpness of a peak of a frequency-specific correlation function, similarly to the case of g₃ in a Gaussian function. Other than this, a cosine function or a uniform function is usable.

As parameters g₁ to g₅ used for a kernel function, instead of a constant, a value differing depending on a frequency k may be usable. In other words, a function of a frequency k is employable as in g₁(k) to g₅(k). For example, g₃ is set as a function g₃(k) of a frequency k, and is set as a function having a small value with an increase in frequency. As such a representative example, when a reciprocal of k is set as a function g₃(k) function, g₃(k) is given as follows.

$$\begin{matrix}[ Math . 23 ] & \\ {g}_{3} ( k ) = \frac{{G}_{3}}{k} & ( 23 )\end{matrix}$$

wherein, G₃ is a real number. In this case, a kernel function G(k) becomes a function in which as a frequency k is higher, a peak is sharper and a tail is narrower.

The multiplication unit 832 calculates a product of a frequency-specific basic cross-spectrum supplied from the frequency-specific basic cross-spectrum calculation unit 2031ₖ and a kernel function spectrum supplied from the kernel function spectrum storage unit 831, and transfers to the integrated correlation function calculation unit 204 as a frequency-specific cross-spectrum. When a frequency-specific basic spectrum supplied from the frequency-specific basic cross-spectrum calculation unit 2031ₖ is designated as Uₖ(w,n), and a kernel function spectrum supplied from the kernel function spectrum storage unit 831 is designated as G(w), a frequency-specific cross-spectrum UMₖ(w,n) is calculated as follows.

[Math. 24]

UMₖ(w,n)=G(w)Uₖ(w,n) (24)

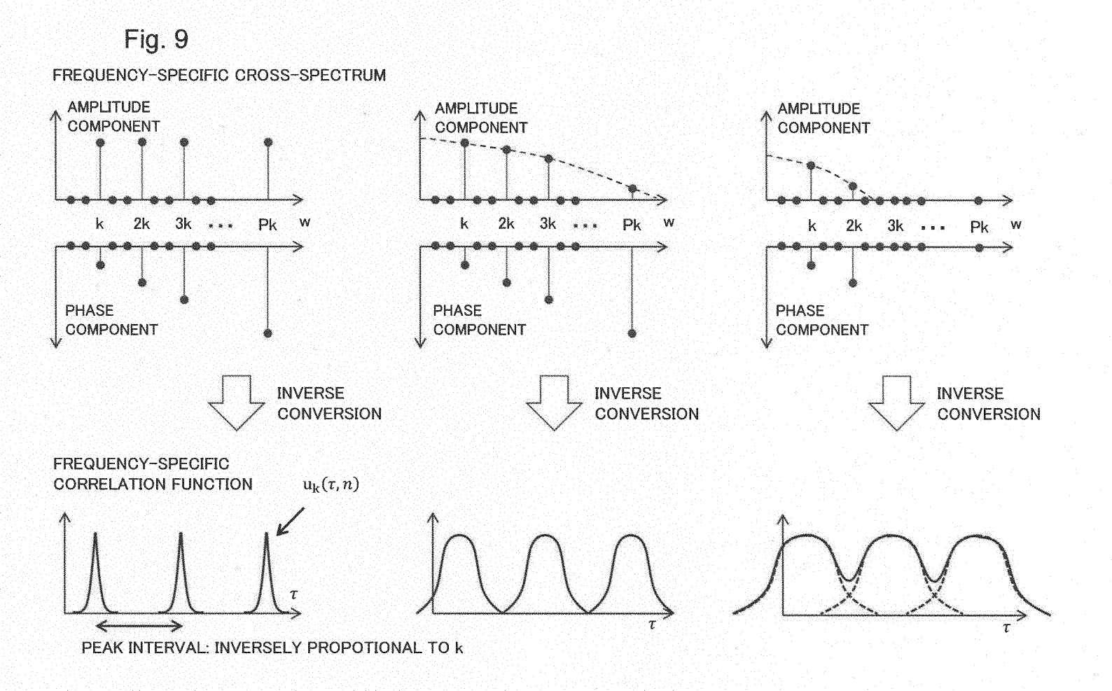

In this manner, when a frequency-specific basic cross-spectrum is multiplied by a kernel function spectrum, a height of a frequency-specific correlation function acquired by the frequency-specific correlation function generation units 241ₖ included in the integrated correlation function calculation unit 204 can be changed. FIG. 9 illustrates a relation between a frequency-specific cross-spectrum multiplied by a kernel function spectrum and a frequency-specific correlation function. For comparison, a frequency-specific cross-spectrum before being multiplied by a kernel function spectrum is also illustrated. As illustrated in the left side diagram of FIG. 4, without multiplication by a kernel function spectrum, a component at a high frequency exists, and therefore a peak of a frequency-specific correlation function is sharp. On the other hand, as in the central diagram and the right side diagram of FIG. 9, when a kernel spectrum function is multiplied, a component of a high frequency attenuates, and therefore sharpness of a peak of a frequency-specific correlation function is small. In other words, as a peak of a kernel spectrum function is sharper (a tail of a kernel spectrum function is narrower), sharpness of a peak of a frequency-specific correlation function is smaller. Further, as in the right side diagram of FIG. 9, when a tail of a frequency-specific correlation function largely widens, a tail of an adjacent mound overlaps, and a frequency-specific correlation function having a shallow valley is acquired.

A relation in shape between a kernel function and a kernel function spectrum is supplementarily described. Due to a nature of Fourier transform, a relation in shape is reverse. As a peak of a kernel function is sharper and a tail is narrower, a peak of a kernel function spectrum is closer to a flat state and a tail widens. When description is made by including a relation with g₃ that adjusts width of a Gaussian function, as g₃ is larger, width of a Gaussian function increases but width of a spectrum thereof decreases.

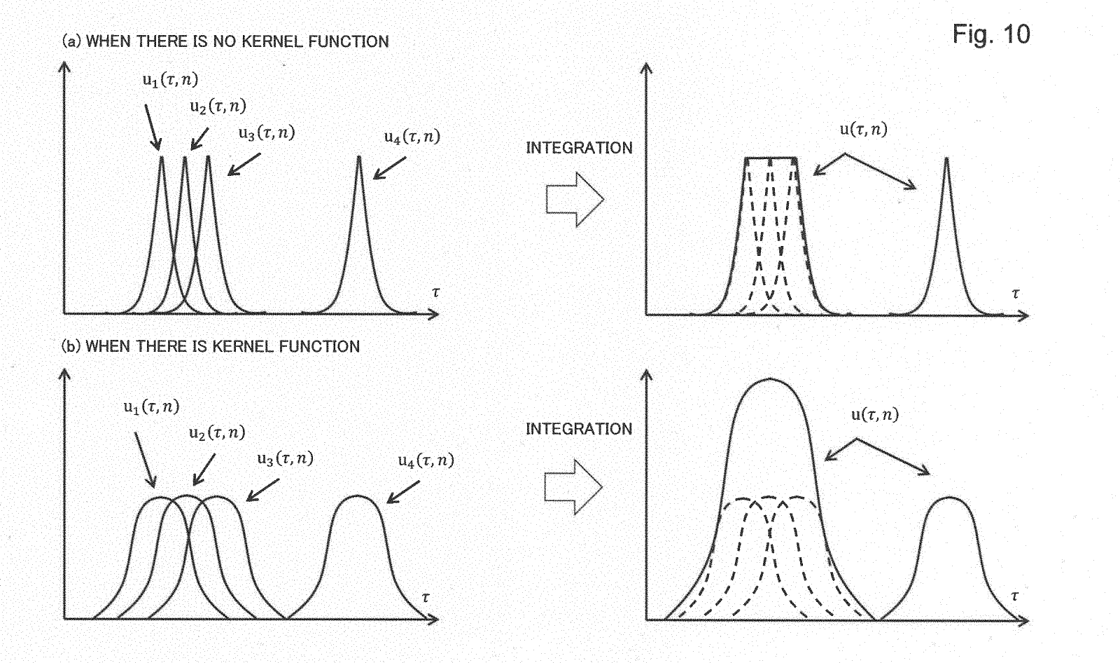

An effect of controlling a height of a frequency-specific correlation function by using a kernel function is described in FIG. 10. FIG. 10 is a diagram illustrating a relation between a presence or absence of a kernel function and an integrated correlation function. When there is no kernel function as illustrated in (a) of FIG. 10, peak positions of frequency-specific correlation functions u₁(τ,n) to u₃(τ,n) are close to each other, but widths of u₁(τ,n) to u₃(τ,n) are narrow and therefore it is difficult to form a large peak upon integration. Therefore, a position of a peak is not clear. On the other hand, when there is a kernel function as illustrated in (b) of FIG. 10, widths of frequency-specific correlation functions are wide, and therefore u₁(τ,n) to u₃(τ,n) can form a large peak via integration. Therefore, compared with the case of the absence of a kernel function of (a), a position of a peak is clear.

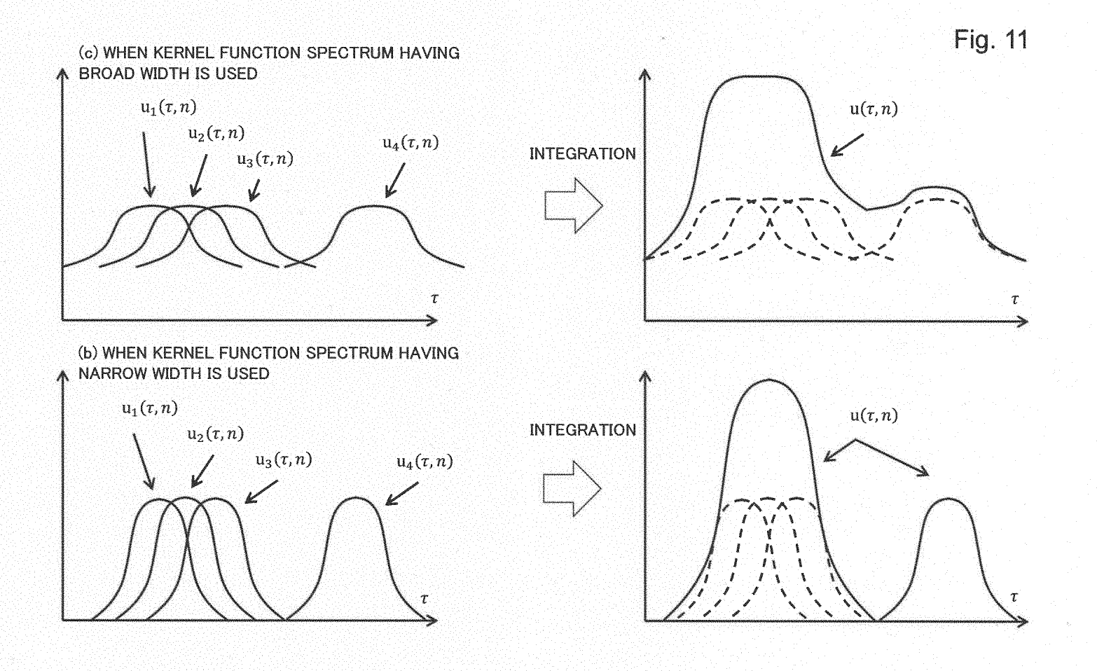

Further, another effect of controlling a height of a frequency-specific correlation function by using a kernel function is described in FIG. 11. FIG. 11 is a diagram illustrating a relation between a difference of a width of a kernel function spectrum and an integrated correlation function. As illustrated in the right side diagram of FIG. 9, when a kernel function spectrum having a broad width is used, a frequency-specific correlation function having a shallow valley is generated, due to periodicity of a correlation function. Therefore, as illustrated in (c) of FIG. 11, when frequency-specific correlation functions having a shallow valley are integrated, an integrated correlation function having a shallow valley, i.e. having an undistinguished peak is generated. On the other hand, as illustrated in the central diagram of FIG. 9, when a kernel function spectrum having a narrow width is used, a frequency-specific correlation function having a deeper valley than in the right diagram of FIG. 9 is formed. Therefore, as illustrated in (d) of FIG. 11, an integrated correlation function having a clear peak is generated.

In the present example embodiment, while a product of a kernel function spectrum acquired by Fourier transform of a kernel function and a frequency-specific basic cross-spectrum is calculated, the present example embodiment can be achieved in a time domain due to a nature of Fourier transform. Instead of the frequency-specific cross-spectrum calculation unit 803ₖ, it is possible that a “convolution operation unit” that convolves a kernel function is provided in a subsequent stage of the frequency-specific correlation function generation unit 241ₖ included in the integrated correlation function calculation unit 204, and a kernel function is convolved with a frequency-specific correlation function supplied from the frequency-specific correlation function generation unit 241ₖ. However, a convolution operation needs a large amount of calculation, and therefore a product based on a frequency domain is more efficiently calculated as in the present example embodiment.

According to the present example embodiment, a frequency-specific basic cross-spectrum is multiplied by a kernel function spectrum and thereby a frequency-specific cross-spectrum is generated. Therefore, a width of a frequency-specific correlation function acquired by inverse conversion is widen, and a peak of an integrated correlation function is clear. In particular, while peak positions of individual frequency-specific correlation functions are close to each other, when each function has a sharp peak, a clarification effect of a peak of an integrated correlation function increases by executing correction.

### Fifth Example Embodiment

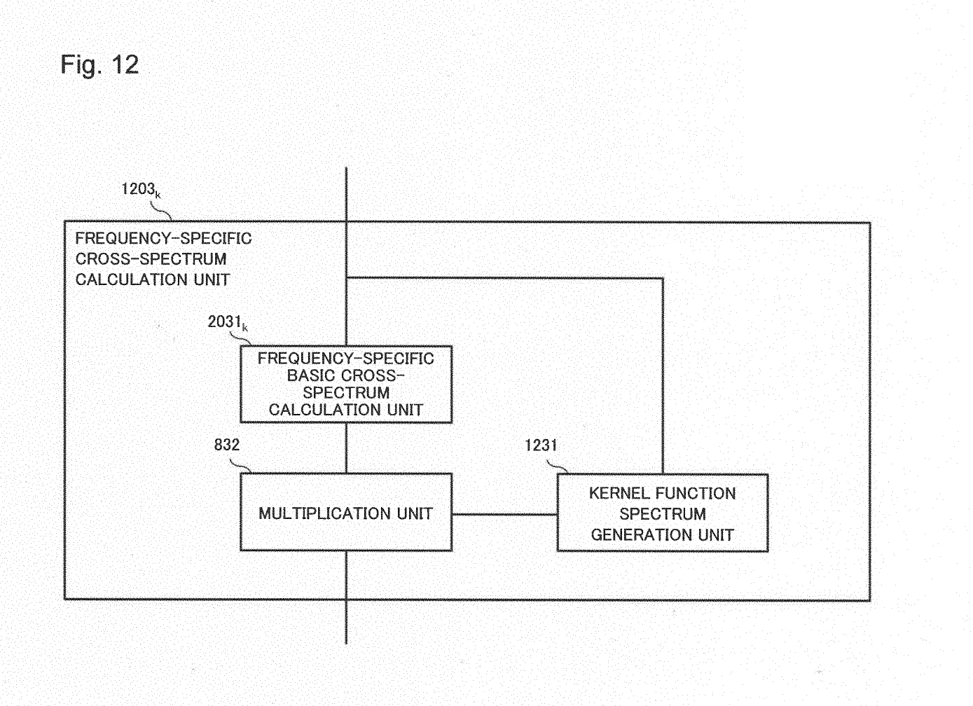

Next, a wave source direction estimation device according to a fifth example embodiment of the present invention is described by using FIG. 12. FIG. 12 is a diagram illustrating a configuration of a frequency-specific cross-spectrum calculation unit included in the wave source direction estimation device according to the present example embodiment. A frequency-specific cross-spectrum calculation units 1203ₖ included in the wave source direction estimation device according to the present example embodiment is different from the fourth example embodiment in a point that instead of the kernel function spectrum storage unit 831, a kernel function spectrum generation unit 1231 is included. Other components and operations are similar to the fourth example embodiment, and therefore the same component and operation are assigned with the same reference signs and detailed description thereof is omitted.

The kernel function spectrum generation unit 1231 generates a kernel function spectrum by using a cross-spectrum supplied from a cross-spectrum calculation unit 202, and transfers the generated kernel function spectrum to a multiplication unit 832. The kernel function spectrum generation unit 1231 analyzes the supplied cross-spectrum, determines a possibility that a target sound exists in an input signal, and generates a kernel function spectrum having a shape reflected with the existence possibility. Basically, when an existence possibility is low, a kernel function spectrum having a narrow width and small broadening. Thereby, a peak of a frequency-specific correlation function is low, and therefore a possibility that an erroneous peak appears in an integrated correlation function can be reduced.

As a method for determining an existence possibility of a target sound, a method for estimating a signal-to-noise ratio (SNR) of an input signal is described. First, an absolute value of a supplied cross-spectrum is calculated. In general, while a spectrum acquired by squaring a Fourier transform acquired in a conversion unit 201 is referred to as an input signal power spectrum, in the present example embodiment, an absolute value of a cross-spectrum is handled as an input signal power spectrum. Next, a power spectrum of a noise component (non-target sound component) in the input signal is estimated, based on the input signal power spectrum. When the input signal power spectrum is designated as P_{X}(k,n), P_{X}(k,n) is calculated as follows.

[Math. 25]

P_{X}(k,n)=|S₁₂(k,n)| (25)

Next, a power spectrum of a noise component is estimated based on the input signal power spectrum. Herein, the method described in NPL 3 is used. It is assumed that the estimated noise power spectrum is a spectrum acquired by averaging power spectra in an estimation initial stage where an input signal power spectrum starts being supplied. In this case, it is necessary to satisfy a condition that a target sound is not included immediately after starting estimation. When an estimated noise power spectrum is designated as P_{N}(k,n), P_{N}(k,n) is calculated as follows.

$$\begin{matrix}[ Math . 26 ] & \\ {P}_{N} ( k , n ) = \{ \begin{matrix}\frac{1}{{N}_{0}} {\sum }_{n = 1}^{{N}_{0}} {P}_{X} ( k , n ) & n > {N}_{0} \\ {P}_{X} ( k , n ) & n \leq {N}_{0}\end{matrix} & ( 26 )\end{matrix}$$

wherein N₀ is a previously determined integer.

As another method, a method for determining an estimated noise power spectrum from a minimum value (minimum statistical value) of an input signal power spectrum is disclosed in NPL 4. In this method, a minimum value of an input signal power spectrum within a fixed time period is stored for each frequency, and a noise component is estimated from the minimum value. A minimum value of an input signal power spectrum is similar in spectrum shape to a noise power spectrum, and therefore can be used as an estimated value of a noise power spectrum.

After an estimated noise power spectrum is acquired, a ratio to an input signal power spectrum is calculated and an estimated value of an SNR is determined. When an input signal power spectrum is designated as P_{X}(k,n) and an estimated noise power spectrum is designated as P_{N}(k,n), an estimated SNR γ(k,n) is calculated as follows.

$$\begin{matrix}[ Math . 27 ] & \\ γ ( k , n ) = \frac{{P}_{X} ( k , n )}{{P}_{N} ( k , n )} & ( 27 )\end{matrix}$$

γ(k,n) that is an estimated SNR is used for an existence possibility q(k,n) of a target sound as-estimated.

An estimated SNR acquired in this manner is referred to as an estimated a-posteriori SNR in NPL 3. For an estimated SNR, instead of an estimated a-posteriori SNR, an estimated a-priori SNR acquired by the method described in NPL 3 is usable. In estimation of an a-priori SNR, a noise component is suppressed and then an SNR is estimated, and therefore high estimation accuracy can be achieved, compared with an a-posteriori SNR, while an amount of calculation increases.

A method for calculating an existence possibility of a target sound by using an input signal power spectrum and an estimated noise power spectrum is not limited to a ratio of both as in an estimated SNR. Instead of a ratio, for example, a difference between both is usable. Further, a simple magnitude relation is usable.

A method for determining a possibility that a target sound exists by analyzing a cross-spectrum is not limited to a method using a power spectrum. As another representative example, a method for analyzing a phase component of a cross-spectrum is cited. As a method for analyzing a phase component, a method using a group delay (a phase component is differentiated in a frequency direction) of a cross-spectrum is described. First, a group delay of a cross-spectrum is determined. When a group delay is designated as gd(k,n), a group delay of a cross-spectrum S₁₂(k,n) is calculated as follows.

[Math. 28]

gd(k,n)=S₁₂(k,n)−S₁₂(k−1,n) (28)

An average value of gd(k,n) is calculated, and a degree of deviation from the average value is set as an existence possibility. When, for example, an existence possibility of a target sound is calculated by using a Gaussian function, an existence possibility q(k,n) is calculated as follows.

$$\begin{matrix}[ Math . 29 ] & \\ q ( k , n ) = exp ( - \frac{{( gd ( k , n ) - \overline{gd ( k , n )} )}^{2}}{2 {q}_{0}} ) & ( 29 )\end{matrix}$$

wherein q₀ is a positive real number. Further, a gd(k,n) bar is a value acquired by averaging gd(k,n) in a frequency direction. There are various methods in averaging and, for example, an arithmetic average as follows is usable.

$$\begin{matrix}[ Math . 30 ] & \\ \overline{gd ( k , n )} = \frac{1}{K - 1} {\sum }_{k = 0}^{K - 1} gd ( k , n ) & ( 30 )\end{matrix}$$

Referring to equation (29), when gd(k,n) is close to a gd(k,n) bar, q(k,n) approaches 1. On the other hand, as gd(k,n) recedes from a gd(k,n) bar, q(k,n) approaches 0.

Next, by using the acquired existence possibility, a kernel function spectrum is generated. Herein, an example in which a parameter of a kernel function that is a base of a kernel function spectrum is controlled is described. Further, as a kernel function, an example in which a Gaussian function is used is described. When an existence possibility of a target sound is high, g₃ is set to be small. Thereby, as an existence possibility is higher, a width of g(τ) is narrower, and a shape in which a g(τ) peak is emphasized is approached. In order to determine g₃ from an existence possibility of a target sound, a linear function in which a reciprocal of the existence possibility is a variable is used. In this case, when the existence possibility is designated as q(k,n), g₃ is calculated as follows.

$$\begin{matrix}[ Math . 31 ] & \\ {g}_{3} = \frac{{a}_{1}}{q ( k , n )} + {b}_{1} & ( 31 )\end{matrix}$$

wherein a₁ and b₁ each are a real number and satisfy a₁>0.0 and b₁>0.0. A function for determining g₃ from an existence possibility q(k,n) of a target sound is not limited to a linear function. A function expressed by another form such as a sigmoid function, a high-order polynomial function, a non-linear function is also usable, instead of a linear function.

When a logistic function is used as a kernel function, g₅ may be calculated by using a method similar to the method for g₃. As a result, when an existence possibility of a target sound is high, g₅ is small, and therefore a width of a kernel function g(τ) is narrow and a shape in which a peak is emphasized is approached.

A parameter is generated from an existence possibility in this manner, and then a kernel function and a kernel function spectrum are generated.

According to the present example embodiment, an existence possibility of a target sound is determined and a kernel function is calculated based on the possibility. When the possibility is high, a width of a kernel function spectrum is widen and a shape approaches a flat shape. Inversely, when the possibility is low, a width of a kernel function spectrum is narrow. Thereby, a peak of a frequency-specific correlation function of a frequency in which a target sound exists becomes high, and a peak of a frequency-specific correlation function of a frequency in which a target sound does not exist becomes low. From the above description, a peak of an integrated correlation function is emphasized more than in the fourth example embodiment, and direction estimation accuracy of a target sound is improved. In particular, a frequency-specific correlation function of a non-target sound becomes low, and therefore a possibility that an erroneous peak appears in an integrated correlation function can be reduced.

### Sixth Example Embodiment

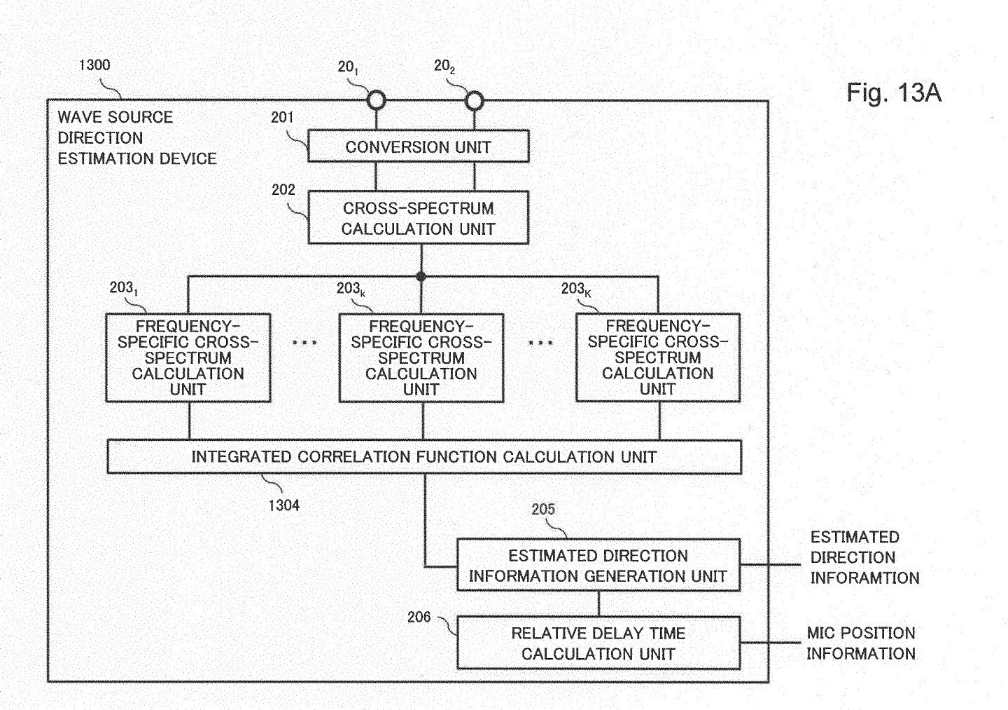

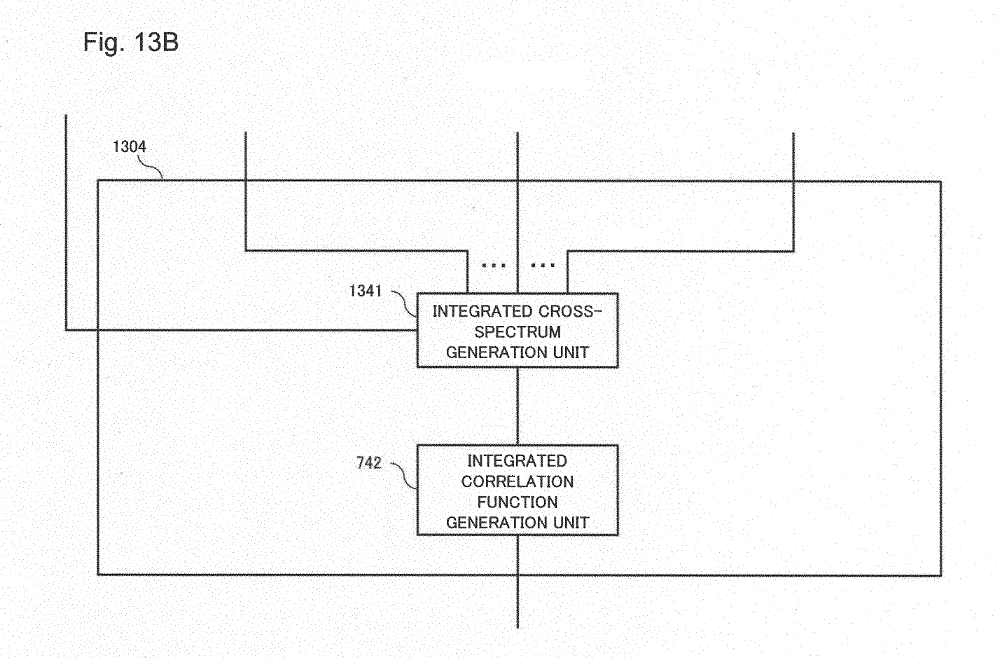

Next, a wave source direction estimation device according to a sixth example embodiment of the present invention is described by using FIG. 13A and FIG. 13B. FIG. 13A is a block diagram illustrating a configuration of a wave source direction estimation device 1300 according to the present example embodiment. The wave source direction estimation device 1300 according to the present example embodiment is different from the third example embodiment in a point that instead of the integrated correlation function calculation unit 204, an integrated correlation function calculation unit 1304 is included. Other components and operations are similar to the third example embodiment, and therefore the same component and operation are assigned with the same reference signs and detailed description thereof is omitted.

FIG. 13B is a block diagram illustrating a configuration of a frequency-specific cross-spectrum included in the wave source direction estimation device according to the sixth example embodiment of the present invention. A frequency-specific cross-spectrum calculation unit 203ₖ according to the present example embodiment is different from the third example embodiment in a point that instead of the integration unit 741, an integrated cross-spectrum generation unit 1341 is included. Other components and operations are similar to the third example embodiment, and therefore the same component and operation are assigned with the same reference signs and detailed description thereof is omitted.

The integrated cross-spectrum generation unit 1341 integrates, based on a cross-spectrum supplied from a cross-spectrum calculation unit 202, frequency-specific cross-spectra supplied from frequency-specific cross-spectrum calculation units 203₁, 203₂, . . . , 203_{K}, and transfers to an integrated correlation function generation unit 742 as an integrated cross-spectrum. In the third example embodiment, a case where a frequency in which a target sound exists or a frequency in which a power of a target sound is large is previously known has been described. In the present example embodiment, a supplied cross-spectrum is analyzed, a possibility that a target sound exists in an input signal is determined, and integration is executed based on the existence possibility.

First, an existence possibility of a target sound is determined based on a supplied cross-spectrum. For calculation of an existence possibility, the method described in the fifth example embodiment can be used in a similar manner. Next, by using the determined existence possibility, frequency cross-spectra are integrated. First, when an existence possibility of a target sound is designated as q(k,n), a set of frequencies Ω in which a possibility that a target sound exists is high is determined based on q(k,n). When q(k,n) with respect to a certain frequency k exceeds a previously determined threshold θ_{q}, the frequency is set as an element of the set Ω. When this is represented by a mathematical equation, the following is established.

[Math. 32]

Ω={k∈{0,1, . . . ,K−1}|q(k,n)>θq} (32)

When a set Ω is determined, the method described in the third example embodiment may be used. Specifically, determination may be made by using the calculation equation represented by equation (17) or equation (18).

Further, it is possible that a weight is calculated by using an existence possibility q(k,n) and integration based on a weighted sum may be executed by using the weight. When a weighting function is designated as η(q(k,n)), an integrated cross-spectrum U(k,n) is calculated as follows.

$$\begin{matrix}[ Math . 33 ] & \\ U ( k , n ) = η ( q ( k , n ) ) \cdot {\sum }_{w = 0}^{W - 1} {U}_{k} ( w , n ) & ( 33 )\end{matrix}$$

However, it is assumed that a weighting function η(q(k,n)) is a monotonically increasing function that takes a large value for a large q(w,n).

According to the present example embodiment, an existence possibility of a target sound is determined based on a cross-spectrum, and then, an integrated cross-spectrum is calculated by using the existence possibility. Therefore, even in a state where an existence possibility of a target sound is previously unknown, band selection and weighting during integrated cross-spectrum generation are appropriately executed, and therefore high estimation accuracy can be achieved.

### Seventh Example Embodiment

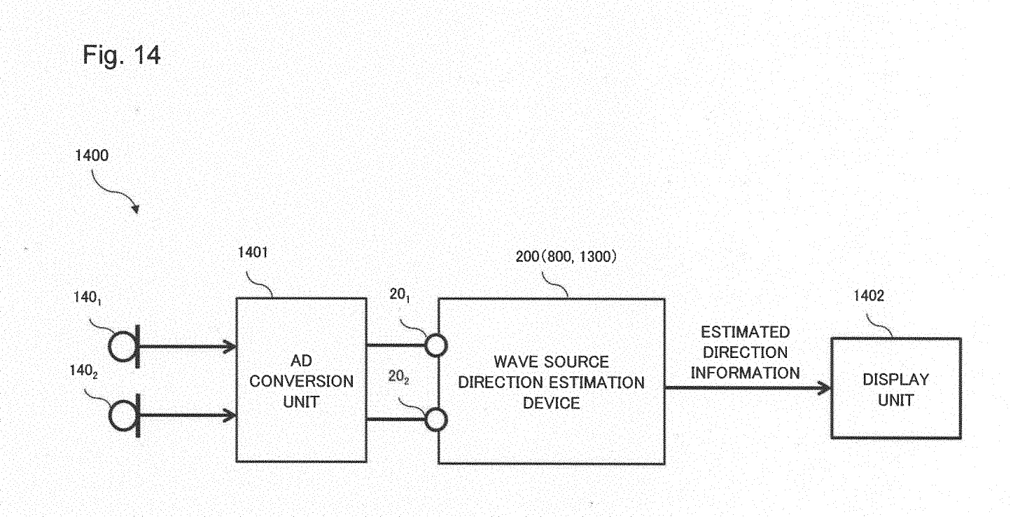

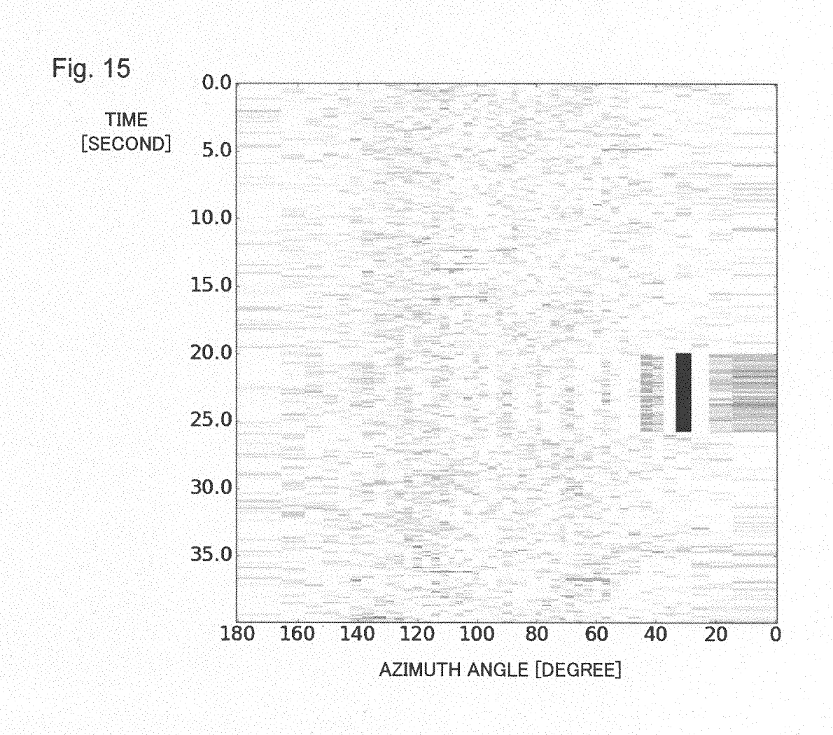

Next, a wave source direction estimation system according to a seventh example embodiment of the present example embodiment is described by using FIG. 14 and FIG. 15. FIG. 14 is a diagram illustrating a configuration of a wave source direction estimation system 1400 according to the present example embodiment. The wave source direction estimation system 1400 according to the present example embodiment uses the wave source direction estimation device 200 according to the second example embodiment. Therefore, the same component and operation as in the second example embodiment are assigned with the same reference signs and detailed description thereof is omitted.

The wave source direction estimation system 1400 according to the present example embodiment includes a mic 140₁, a mic 140₂, an AD conversion unit 1401, and a display unit 1402. Note that, in the present example embodiment, instead of the wave source direction estimation device 200, a wave source direction estimation device 800 or a wave source direction estimation device 1300 can be used. Further, while assuming that a wave source is a sound source, description is made and therefore an example using a mic is described, in a case other than a sound source, various types of sensors, which are capable of receiving a wave emitted from a wave source thereof and converting the received wave into an electric signal, are used, instead of a mic.

The mic 140₁ and the mic 140₂ convert a sound of a device periphery including a sound generated from a target object as an estimated target into an electric signal, and transfers the converted electric signal to the AD conversion unit 1401. When a medium where a sound propagates is an air medium, a sound arrives at a mic as a vibration of air. The mic converts the arrived vibration of air into an electric signal.

The AD conversion unit 1401 convert electric signals of sounds supplied from the mic 140₁ and the mic 140₂ into digital signals, and transfer the converted digital signals to an input terminal 20₁ and an input terminal 20₂.

The display unit 1402 converts estimated direction information supplied from the wave source direction estimation device 200 into visible data such as an image, and displays the converted visible data on a display device such as a display. A most basic visualization method is a method for displaying a correlation function at a certain time as a two-dimensional graph. At that time, a direction is displayed in a horizontal axis, and a correlation value is displayed in a vertical axis. A method for three-dimensionally displaying a time change of a correlation function, in addition to a certain time, is also effective. A time change is displayed, and thereby clarification of appearance of a target sound source, a movement pattern of the target sound source, prediction of a movement direction of the target sound source, and the like can be made possible. Instead of three-dimension, a method for projection on a two-dimensional plane is also effective. In three-dimension, there is a problem that it is difficult to view a back side when displayed. When display on a plane through projection from an upper side is performed, there is no blind angle, and browsability is improved. A correlation value may be expressed by a contour, instead of a density of a color.

FIG. 15 is a diagram illustrating one example of an image displayed on the display unit 1402 of the wave source direction estimation system 1400 according to the present example embodiment, and the diagram is acquired from estimated direction information supplied from the wave source direction estimation device 200. This was acquired in order to confirm an advantageous effect of the present example embodiment. In generation of the example, a sound in a situation where a scream occurred at times 20 seconds to 25 seconds in an azimuth of 30 degrees in a street environment was used. Sound collection was performed by using two mics installed at a several centimeters spacing.

FIG. 15 indicates that as a color approaches black, a correlation value is higher. A range of an azimuth angle is 0 to 180 degrees. The vertical axis indicates a time. Referring to FIG. 15, it is understood that at times approximately 20 seconds to 25 seconds, a correlation value of an azimuth of 30 degrees is high. From this, it is understood that a scream occurs at times 20 seconds to 25 seconds and an occurrence direction of the scream is approximately 30 degrees.

According the present example embodiment, estimated direction information is displayed as visible data such as an image, and therefore a user can visually understand direction estimation information of a wave source.

### Other Example Embodiments

While the present invention has been described with reference to example embodiments thereof, the present invention is not limited to example embodiments described above. Various modifications that can be understood by a person skilled in the art can be made within the scope of the present invention. Further, a system or a device in which separate features include in each example embodiment are combined in any manner is also included in the scope of the present invention.

Further, the present invention is also applicable to a system including a plurality of devices or is applicable to a single device. Furthermore, the present invention is also applicable when an information processing program that achieves a function of an example embodiment is supplied to a system or a device directly or remotely. Therefore, in order to achieve a function of the present invention by a computer, a program installed on the computer, a medium that stores the program, or a world wide web (www) server on which the program is downloaded, is also included in the scope of the present invention. In particular, at least a non-transitory computer readable medium that stores a program, that causes a computer to execute processing steps included in the example embodiments described above, is included in the scope of the present invention.

### Other Expressions of Example Embodiments

The whole or part of the example embodiments described above can be described as, but not limited to, the following supplement notes.

### Supplement Note 1

A correlation function generation device including:

a plurality of input signal acquisition means that acquire a wave generated by a wave source as an input signal;

a conversion means that converts a plurality of the input signals acquired by the input signal acquisition means into a plurality of frequency-domain signals;

a cross-spectrum calculation means that calculates a cross-spectrum, based on the frequency-domain signals;

a frequency-specific cross-spectrum calculation means that calculates a frequency-specific cross-spectrum, based on the cross-spectrum; and

an integrated correlation function calculation means that calculates an integrated correlation function, based on the frequency-specific cross-spectrum.

### Supplement Note 2

The correlation function generation device according to supplement note 1, wherein

the integrated correlation function calculation means includes:

a frequency-specific correlation function generation means that generates a frequency-specific correlation function by inversely converting the frequency-specific cross-spectrum; and

an integrated correlation function generation means that integrates the frequency-specific correlation function and generates one integrated correlation function

### Supplement Note 3

The correlation function generation device according to supplement note 1, wherein

the integrated correlation function calculation means includes:

an integrated cross-spectrum generation means that integrates the frequency-specific cross-spectrum and generates an integrated cross-spectrum; and

an integrated correlation function generation means that generates an integrated correlation function by inversely converting the integrated cross-spectrum.

### Supplement Note 4

The correlation function generation device according to any one of supplement notes 1 to 3, wherein

the frequency-specific cross-spectrum calculation means includes

a frequency-specific basic cross-spectrum calculation means that calculates a frequency-specific basic cross-spectrum, based on the cross-spectrum, and

determines the frequency-specific basic cross-spectrum as the frequency-specific cross-spectrum.

### Supplement Note 5

The correlation function generation device according to any one of supplement notes 1 to 3, wherein

the frequency-specific cross-spectrum calculation means includes:

a frequency-specific basic cross-spectrum calculation means that calculates a frequency-specific basic cross-spectrum, based on the cross-spectrum;

a kernel function storage means that stores a kernel function spectrum; and

a multiplication means that multiplies the frequency-specific basic cross-spectrum and the kernel function spectrum, and determines the frequency-specific cross-spectrum.

### Supplement Note 6

The correlation function generation device according to any one of supplement notes 1 to 3, wherein the frequency-specific cross-spectrum calculation means includes:

a frequency-specific basic cross-spectrum calculation means that calculates a frequency-specific basic cross-spectrum, based on the cross-spectrum;

a kernel function spectrum calculation means that calculates a kernel function spectrum, based on the cross-spectrum; and

a multiplication means that multiplies the frequency-specific basic cross-spectrum and the kernel function spectrum, and determines the frequency-specific cross-spectrum.

### Supplement note 7

A correlation function generation method including:

a plurality of input signal acquisition steps of acquiring a wave generated by a wave source as an input signal;

a conversion step of converting a plurality of the input signals acquired in the input signal acquisition steps into a plurality of frequency-domain signals;

a cross-spectrum calculation step of calculating a cross-spectrum, based on the frequency-domain signals;

a frequency-specific cross-spectrum calculation step of calculating a frequency-specific cross-spectrum, based on the cross-spectrum; and

an integrated correlation function calculation step of calculating an integrated correlation function, based on the frequency-specific cross-spectrum.

### Supplement Note 8

A correlation function generation program that causes a computer to execute:

a plurality of input signal acquisition steps of acquiring a wave generated by a wave source as an input signal;

a conversion step of converting a plurality of the input signals acquired in the input signal acquisition steps into a plurality of frequency-domain signals;

a cross-spectrum calculation step of calculating a cross-spectrum, based on the frequency-domain signals, a frequency-specific cross-spectrum calculation step of calculating a frequency-specific cross-spectrum, based on the cross-spectrum; and

an integrated correlation function calculation step of calculating an integrated correlation function, based on the frequency-specific cross-spectrum.

### Supplement Note 9

A wave source direction estimation device including:

the correlation function generation device according to any one of supplement notes 1 to 6; and

an estimated direction information generation means that generates estimated direction information of a wave source, based on an integrated correlation function.

This application is based upon and claims the benefit of priority from Japanese patent application No. 2016-128486, filed on Jun. 29, 2016, the disclosure of which is incorporated herein in its entirety by reference.

What is claimed is:

1. A correlation function generation device comprising:
a plurality of input signal acquisition unit acquiring a wave generated by a wave source as an input signal;
a conversion unit converting a plurality of the input signals acquired by the input signal acquisition unit into a plurality of frequency-domain signals;
a cross-spectrum calculation unit calculating a cross-spectrum, based on the frequency-domain signals;
a frequency-specific cross-spectrum calculation unit calculating a frequency-specific cross-spectrum, based on the cross-spectrum; and
an integrated correlation function calculation unit calculating an integrated correlation function, based on the frequency-specific cross-spectrum.

2. The correlation function generation device according to claim 1, wherein
the integrated correlation function calculation unit includes:
a frequency-specific correlation function generation unit generating a frequency-specific correlation function by inversely converting the frequency-specific cross-spectrum; and
an integrated correlation function generation unit integrating the frequency-specific correlation function and generating one integrated correlation function.

3. The correlation function generation device according to claim 1, wherein the integrated correlation function calculation unit includes:
an integrated cross-spectrum generation unit integrating the frequency-specific cross-spectrum and generating an integrated cross-spectrum; and
an integrated correlation function generation unit generating an integrated correlation function by inversely converting the integrated cross-spectrum.

4. The correlation function generation device according to claim 1, wherein
the frequency-specific cross-spectrum calculation unit includes
a frequency-specific basic cross-spectrum calculation unit calculating a frequency-specific basic cross-spectrum, based on the cross-spectrum, and
the frequency-specific cross-spectrum calculation unit determines the frequency-specific basic cross-spectrum as the frequency-specific cross-spectrum.

5. The correlation function generation device according to claim 1, wherein
the frequency-specific cross-spectrum calculation unit includes:
a frequency-specific basic cross-spectrum calculation unit calculating a frequency-specific basic cross-spectrum, based on the cross-spectrum;
a kernel function storage unit storing a kernel function spectrum; and
a multiplication unit multiplying the frequency-specific basic cross-spectrum and the kernel function spectrum, and determining the frequency-specific cross-spectrum.

6. The correlation function generation device according to claim 1, wherein
the frequency-specific cross-spectrum calculation unit includes:
a frequency-specific basic cross-spectrum calculation unit calculating a frequency-specific basic cross-spectrum, based on the cross-spectrum;
a kernel function spectrum calculation unit calculating a kernel function spectrum, based on the cross-spectrum; and
a multiplication unit multiplying the frequency-specific basic cross-spectrum and the kernel function spectrum, and determining the frequency-specific cross-spectrum.

7. A correlation function generation method comprising:
acquiring a wave generated by a wave source as an input signal;
converting a plurality of the input signals acquired in the input signal acquisition steps into a plurality of frequency-domain signals;
calculating a cross-spectrum, based on the frequency-domain signals;
calculating a frequency-specific cross-spectrum, based on the cross-spectrum; and
calculating an integrated correlation function, based on the frequency-specific cross-spectrum.

8. A correlation function generation program which causes a computer to execute:
acquiring a wave generated by a wave source as an input signal;
converting a plurality of the input signals acquired in the acquisition into a plurality of frequency-domain signals;
calculating a cross-spectrum, based on the frequency-domain signals,
calculating a frequency-specific cross-spectrum, based on the cross-spectrum; and
calculating an integrated correlation function, based on the frequency-specific cross-spectrum.

9. A wave source direction estimation device comprising:
the correlation function generation device according to claim 1; and
estimated direction information generation means for generating estimated direction information of a wave source, based on an integrated correlation function.
